(19) United States
(12) Patent Application Publication
(10) Pub. No.: US 2005/0208304 A1
(43) Pub. Date: Sep. 22, 2005

(54) Coatings for carbon nanotubes

(75) Inventors: Charles Patrick Collier, San Marino, CA (US); Konstantinos P. Giapis, Pasadena, CA (US); Maria J. Esplandiu, Premia de Mar (ES)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: California Institute of Technology, Pasadena, CA (US)

(21) Appl. No.: 11/126,795

(22) Filed: May 10, 2005

Related U.S. Application Data
(63) Continuation-in-part of application No. 10/783,713, filed on Feb. 20, 2004.
(60) Provisional application No. 60/449,210, filed on Feb. 21, 2003.
(60) Provisional application No. 60/582,683, filed on Jun. 24, 2004.
(60) Provisional application No. 60/583,122, filed on Jun. 25, 2004.

(51) Int. Cl. B32B 5/16; B05D 7/00

(52) U.S. Cl. 428/403; 428/404; 977/DIG. 1; 427/212; 427/569

(57) ABSTRACT

A coated nanotube that includes an inner nanotube having an exterior surface, and a plasma deposited layer covering at least part of the exterior surface of the inner nanotube. Also, a method of making a coated nanotube, the method where the method includes the steps of generating a plasma from a coating precursor, and exposing an inner nanotube to the plasma, where a plasma deposited layer is formed on at least a portion of the inner nanotube. Additionally, a method of making a coated nanotube that includes the steps of providing an inner nanotube, and evaporating a metal into the inner nanotube, where the metal forms a coating layer on at least a portion of the inner nanotube.

### CROSS-REFERENCES TO RELATED APPLICATIONS

This application is a continuation-in-part of U.S. nonprovisional patent application Ser. No. 10/783,713, filed Feb. 20, 2004, which claims the benefit of U.S. Provisional Patent Application No. 60/449,210, filed Feb. 21, 2003. This application also claims priority to U.S. Provisional patent application No. 60/582,683, filed Jun. 24, 2004, and U.S. Provisional patent application No. 60/583,122, filed Jun. 25, 2004. All the applications are incorporated by reference herein for all purposes.

### STATEMENT AS TO RIGHTS TO INVENTIONS MADE UNDER FEDERALLY SPONSORED RESEARCH OR DEVELOPMENT

Work described herein has been supported, in part, by the Caltech President's Fund, which is co-administered between JPL and NASA (contract NAS7-1407). The work has also been supported, in part by National Institutes of Health grant NIH [1 R21 GM071702-02]. The United States Government may therefore have certain rights in the invention.

### BACKGROUND OF THE INVENTION

Carbon nanotubes hold great promise in many areas of science and technology, due to their unique physical properties and molecular-scale dimensions. A significant technological advance for these materials has been their incorporation as specific molecular transducers in nanosensors, molecular electronics and as molecular manipulation tools. This potential is based on the remarkable molecular recognition capabilities of carbon nanotubes through covalent chemical bonding, surface charge transfer or electrostatic changes when a specific molecule binds to a tube.

In order to achieve this specificity, nanotubes can be chemically, physically or biologically functionalized to recognize a particular target molecule and reject others in a complex environment. In addition, proof-of-principle demonstrations of nanotube functionalization for sensing or binding specific molecules in the gas and liquid phases have been successfully made.

The most commonly used geometry for nanotube based sensors is a chemically or biologically sensitive “field effect transistor”. The nanotube serves as a wire connecting lithographically defined source and drain metal electrodes on a doped silicon substrate having a thin insulating silicon oxide surface layer. Binding occurs over the length of the sides of the nanotubes in these devices. The electrically-conductive doped silicon serves as a backgate; noncovalent binding of target molecules is detected by changes in conductance of the device.

Recent advances in nanotube fabrication and AFM imaging with nanotube tips have demonstrated the potential of these tools to achieve high resolution images. Carbon nanotubes have been attached or grown on silicon AFM tips as high resolution AFM probes.

FIGS. 1A-B show a scanning electron micrographs of individual carbon nanotubes mounted to a silicon AFM probe tip by our team. The nanotube was picked up from a flat substrate supporting SWNTs grown by metal catalyzed chemical vapor deposition.

SWNTs are in many respects, ideal high resolution probe tips for AFM. SWNTs are single carbon atom thick hollow cylinders that are microns in length with diameters ranging from 0.7 to 5 nm. They can be used as high aspect ratio probes with radii comparable to molecular scale dimensions.

Carbon nanotubes are chemically and mechanically robust. They are the stiffest material known, with Young's moduli of about 1.2 TPa, which limits the noise due to thermal vibrations and bending from degrading the ultimate obtainable resolution. Unlike other materials, carbon nanotubes buckle elastically under large loads, limiting damage to both the tips and the sample. Because SWNTs have well-defined molecular structures, interpreting AFM data becomes much easier since the tip-sample interaction is well characterized and reproducible.

As shown by Wong et al., “Covalently-Functionalized Single-Walled Carbon Nanotube Probe Tips for Chemical Force Microscopy”, J. Am. Chem. Soc. 120, 8557-8558 (1998), incorporated herein by reference for all purposes, SWNT AFM probe tips have been chemically functionalized uniquely at their very ends. This can be initiated by an electrical etching process, which is also used to shorten the attached SWNTs in order to achieve lengths suitable for high-resolution imaging. However, this approach still leaves the sides of the SWNT susceptible to non-specific binding of molecular species.

When SWNT tips are etched in an oxidizing environment (for example, in O₂ ambient), the ends become functionalized with one or more carboxyl groups, based on bulk measurements carried out on chemically oxidized nanotubes. The tip can be chemically modified further by coupling organic amines to the carboxylate to form amide bonds. Alternatively, by etching the SWNT in a nitrogen environment, SWNT ends become functionalized with one or more amine groups, directly. The use of reactive amino chemistry is a common biochemical conjugation technique, and can be exploited further to take advantage of a wide range of chemical and biological means available for attaching fluorophores, antibodies, ligands, proteins or nucleic acids to the ends of the nanotubes with well-defined orientations.

The manipulation of a ligand-protein interaction with specific single molecules chemically and biologically coupled to the nanotube tip has been measured with AFM by Wong et al, “Covalently Functionalized Nanotubes as Nanometer Probes for Chemistry and Biology”, Nature, 394, 52-55 (1998), incorporated by reference herein for all purposes. However, nonspecific binding of molecules to the sidewalls of the nanotube is still frequent.

Often this is due to the hydrophobic nature of nanotubes. Hydrophobic sections of proteins or other biological molecules will bind to, and heavily coat, the nanotube sidewalls in a non-specific location. For example, in “Functionalization of Carbon Nanotubes for Biocompatibility and Bio-Molecular Recognition,”Nano Lett. 2, 285 (2002), incorporated by reference herein for all purposes, Shim et al. have shown that the protein streptavidin nonspecifically binds to as-grown SWNTs unless this nonspecific binding is prevented by coating the nanotubes with a surfactant, such as Triton, and poly(ethylene glycol), PEG.

Thus while known approaches have offered promise, improved techniques for employing carbon nanotubes for sensing and other functions are highly desirable.

### BRIEF SUMMARY OF THE INVENTION

Embodiments of the invention include coated nanotubes that have an inner nanotube with an exterior surface. A plasma deposited layer covers at least part of the exterior surface of the inner nanotube.

Embodiments of the invention also include methods of making coated nanotubes. The methods may include generating a plasma from a coating precursor, and exposing an inner nanotube to the plasma to form a plasma deposited layer on at least a portion of the inner nanotube.

Embodiments of the invention still further include a method of making a coated nanotube that includes the steps of providing an inner nanotube, and evaporating a metal into the inner nanotube, where the metal forms a coating layer on at least a portion of the inner nanotube.

Embodiments of the invention further include an apparatus for making a coated nanotube. The apparatus may include a plasma deposition chamber, and a plasma generation system coupled to a plasma generation site in the deposition chamber. The apparatus may also include a plasma precursor supply inlet coupled to the deposition chamber, where the supply inlet provides a conduit for precursors that are converted into the plasma. The apparatus may also include a nanotube substrate holding platform to hold a substrate comprising inner nanotubes, where the holding platform is positioned downstream of the plasma generation site.

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### BRIEF DESCRIPTION OF THE DRAWINGS

FIGS. 1A-B show scanning electron micrographs (SEM) of individual carbon nanotubules mounted on an atomic force microscope (AFM) tip.

FIG. 2 shows a simplified flowchart of steps of one embodiment of a method in accordance with the present invention.

FIG. 3 shows simplified views of pick-up attachment of a single wall carbon nanotube (SWNT) in accordance with an embodiment of the present invention.

FIG. 4 shows an AFM image of SWNTs grown on a pick-up substrate.

FIG. 5A plots an oscillation amplitude signal for an AFM tip for a shortened SWNT.

FIG. 5B plots a cantilever deflection signal for an AFM tip for the shortened SWNT of FIG. 5A.

FIG. 6 shows a transmission electron micrograph of a shortened nanotube at the end of an AFM cantilever tip.

FIG. 7A shows an AFM image of SWNTs on an oxidized silicon substrate, taken using shortened pick-up nanotube tips.

FIG. 7B shows an AFM image of DNA on mica, taken using shortened pick-up nanotube tips.

FIG. 8 shows simplified views of a basic process flow for unique functionalization of the free end of a SWNT.

FIG. 9 shows a simplified schematic view of control over biomolecular dynamics on the molecular scale.

FIG. 10 shows a simplified schematic view of a hybrid AFM/optical microscope apparatus allowing manipulation of functionalized SWNTs.

FIG. 11 shows simplified schematic views of the process of wiring biomolecules to carbon nanotube scanning probes.

FIG. 12A shows a schematic view of an apparatus for achieving SWNT catalyzed vapor deposition growth.

FIG. 12B shows an AFM image of SWNTs grown on a pick-up substrate utilizing the apparatus shown in FIG. 12A.

FIG. 13A shows an electron micrograph of a nanotube probe passivated by an electrochemical polymerization process.

FIG. 13B plots current versus voltage to illustrate the passivation by electrochemical polymerization, of the nanotube probe of FIG. 13A.

FIG. 14A is a simplified flowchart of a method of making a coated nanotube according to embodiments of the invention.

FIG. 14B shows a plasma reactor according to an embodiment of the invention.

FIG. 14C shows an AFM image of a planar graphite substrate coated by a Teflon-like polymer film formed by plasma deposition methods of the present invention.

FIGS. 14D-E show: (D) Oscillation amplitude and (E) deflection vs. z-displacement for a nanoelectrode probe consisting of a metallic nanotube attached to a gold coated AFM tip in contact with a mercury droplet (before applying an electrical etch pulse.)

FIGS. 14F-G show I-V curves taken at the immersion depths indicated with arrows A and B. (F) was recorded before, and (G) was recorded after applying a 5 V electrical etching pulse for 10 μs to the probe.

FIGS. 14H-J show: (H) I-V curve of a probe consisting of a semiconducting nanotube electrically contacted to a gold coated AFM tip, (I) I-V curve showing positive rectification which may have been caused by a metal-semiconductor heterojunction in the nanotube attached to a gold coated tip, and (J) Negative rectification in the I-V characteristic of a nanoelectrode probe which had a bare n-type silicon tip as the support for the nanotube.

FIG. 14K plots current density versus potential for such a Teflon-like polymer film formed on gold electrodes by the same type of gas-phase reaction responsible for forming the passivation layer on the SWNT shown in FIG. 14C.

FIG. 14L shows a roughness analysis of the substrate whose AFM image is shown in FIG. 14M.

FIG. 15 shows a transmission electron microscope (TEM) image of a 5 nm diameter SWNT AFM tip that was originally 200 nm long before contact with water, but had inelastically buckled upon itself multiple times due to the immersion of the tip.

FIGS. 16A-B are: (A) a TEM image of a probe that had been coated with titanium before immersion in water, and (B) a TEM image of a (different) probe after it had been immersed in water.

FIG. 17 shows a simplified view of the use of a SWNT probe in connection with a localized electrochemical reaction.

FIG. 18 is a simplified schematic view of the nanowiring of an enzyme to a carbon nanotube.

FIG. 19A is a simplified schematic view showing use of a nanowired enzymatic probe.

FIG. 19B plots voltage versus time for the enzymatic probe of FIG. 19A.

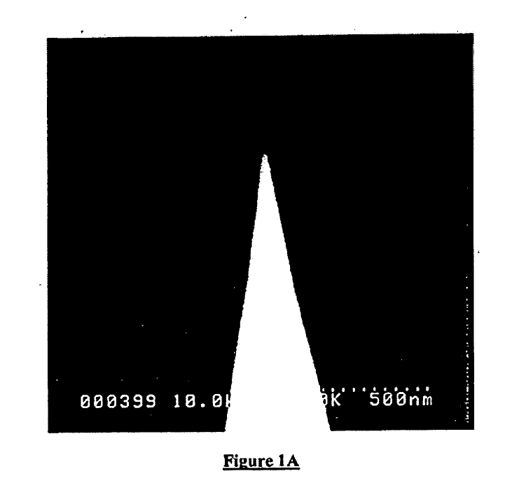

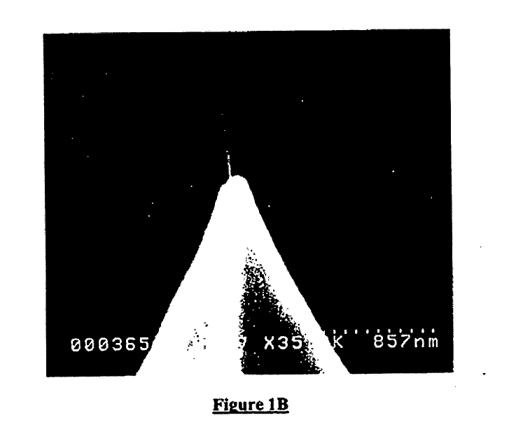

### DETAILED DESCRIPTION OF THE INVENTION

Embodiments of the present invention relate to coated nanotubes, which include an inner nanotube that is at least partially covered by a coating layer. The coating layer may enhance the chemical inertness, solution properties, insulating properties, selective functionalization, and/or rigidity of the inner nanotube, among other properties. For example, the coating layer may be a fluorocarbon layer deposited on a single-wall carbon nanotube (SWNT) with a plasma deposition process. The plasma deposited fluorocarbon layer electrically and chemically insulates the SWNT, preventing surrounding chemicals and solvent from binding to the ends and sidewalls of the inner nanotube. A portion of the fluorocarbon layer may be replaced with a selective sensing material that can change the electrical properties of the nanotube when the sensing material comes in contact with a particular chemical species, or class of chemicals. This allows the coated nanotube to be selectively functionalized to detect a selected chemical with less interference from other chemicals in the detection environment.

The plasma deposited fluorocarbon layer may also increase the rigidity of the inner nanotube. When the coated nanotube is used as the apex of a probe tip in an atomic force microscope (AFM), the increased rigidity lessens bending and vibration in the tip, which boosts the spatial resolution of the AFM. The fluorocarbon layer can also reinforce the attachment of the coated nanotube to the AFM tip without the need for additional adhesives.

Coating layers may also be made from metals and metal oxide coatings formed on at least part of the inner nanotube. For example, a layer of titanium oxide (TiOₓ) may be formed on the ends and sidewalls of a SWNT by evaporating titanium metal in an inductively-coupled oxygen plasma in contact with the nanotubes. The TiOₓ layer is more hydrophilic than the underlying carbon matrix of the inner nanotube, making TiOₓ coated nanotubes useful for measurements in aqueous environments. Embodiments of the invention include TiOₓ coated nanotubes at the apex of an AFM tip that is used to probe chemical and biological processes in aqueous environments. A portion of the TiOₓ coating may be replaced or covered with a material that is selectively functionalized to detect a chemical (such as a metabolic intermediate), or functionalized with a catalyst or a biological enzyme that can effectuate a chemical and/or biological reactions in the aqueous system.

Embodiments in accordance with the present invention also describe a series of techniques, which used alone or in combination, enable the manufacture of a variety of nanoscale devices and sensors, including single-molecule sensors. Furthermore, these techniques enable the devices to be uniquely manufactured at a specific location. Typically, this is achieved through the use of an individual single wall carbon nanotube (SWNT) attached to a scanning atomic force microscope (AFM) tip as a structural scaffold. In alternative embodiments, the location of the functionalized SWNT may be changed relative to a target utilizing a nanoscanner, nanopositioner, or other manipulating device, as described in detail below.

Embodiments of the present invention enable construction of a wide variety of novel nanometer scale devices located at the sensing or exposed end of a nanotube AFM tip. These devices can be used for characterizing molecular conformations, chemical dynamics and behavior, intermolecular dynamics, and a wide variety of materials and devices at nanometer length scales. These devices will extend the utility and sensitivity of scanning probe microscopy in general.

Embodiments in accordance with the present invention rely on the concept of selectively modifying the (free) end of a functionalized SWNT AFM probe through electrical or electrochemical means, thereby fundamentally changing the chemical, electrical, and/or mechanical properties of the tube end relative to the rest of the probe. This modification can be carried out by electrically charging the SWNT through application of an electrical potential between the AFM cantilever and the substrate, leading to ablation or modification of material coating the nanotube tip.

The concept is general, and applies equally well in describing the construction of nanoscale probes based on SWNT functionalization using soft materials for possible use in biological applications, as well as metals, semiconductors and insulators, for building nanoscale solid-state electrical, magnetic and optical devices. The ability to incorporate specific device designs with high-level functionality into scanning probes represents a significant advance in the utility of scanning probe microscopy for nanotechnology, materials science and biophysics.

Embodiments in accordance with the present invention exploit the unique molecular recognition capabilities, mechanical and electronic properties, and length scale of carbon nanotubes, to construct molecule-specific actuators and manipulators integrated on scanning probes. These probes can also function as biosensors capable of detecting specific molecules and sensing changes in (inter)molecular dynamics in combination with fluorescence detection. Interactions between SWNTs and specific biomolecules can be engineered through functionalization of the SWNTs, employing techniques previously developed to construct electronic biosensors based on nanotube transistors.

However, the devices described herein function substantially differently from conventional nanotube-based sensors detecting molecules through electronic transport measurements. In particular, the SWNT probe will serve as a molecular-scale structural support for fabrication of a specific device, through attachment of ligands, enzymes or other biomolecules. Embodiments of devices in accordance with the present invention will induce in biological systems, well-defined biochemical reactions or conformational changes amendable to spectroscopic detection. Fluorescence imaging correlated with one or more of the plurality of data channels an AFM supports, can be used to not only detect and identify single biomolecules, but also to study and eventually control intermolecular dynamics. Electrical conduction through the SWNT can further expand the probe's functional capability.

Conventionally, electronic sensors based on nanotube transistor geometries on planar supports have functioned primarily as static assays. Such conventional devices can sensitively detect and identify specific analytes, but are not intended to interact with or further perturb the sample. By contrast, embodiments in accordance with the present invention are designed to continuously probe a dynamic biological system in real time, and to ultimately influence the organizational evolution and functional capabilities of complex assemblies of individual interacting biomolecules.

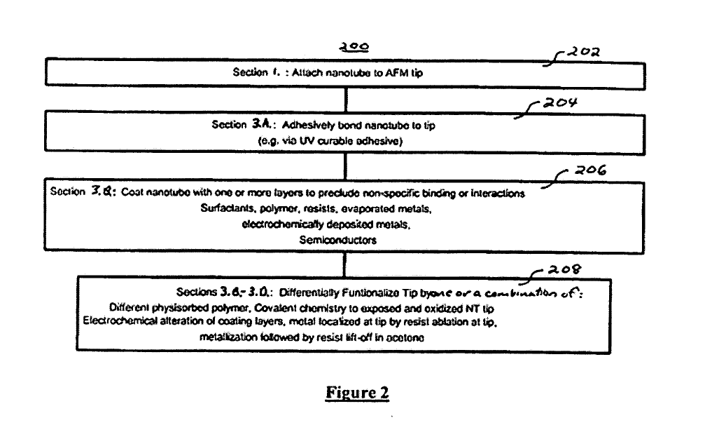

Embodiments in accordance with the present invention comprise methods that enable a single active location to be created for sensing or characterization at the free end of a nanotube. This nanotube is attached to a structural substrate that enables the sensor to be very precisely located. The precise location capability enables a wide variety of high resolution studies, characterization and manipulation to be conducted with unprecedented resolution and sensitivity. A typical process of achieving this is outlined in FIG. 2 and described below.

Embodiments in accordance with the present invention start by attaching a nanotube, single-wall, multi-wall or a rope or bundle of single-wall nanotubes to a supporting structure such as an AFM tip. For AFM tips this can initially be accomplished either by direct growth or more preferably by the pickup technique. Once attached this tube can either be adhesively attached to the tip or left attached via van der Waals forces. The adhesives used can vary considerably. The range covers many common water tolerant adhesives such as Norland Optical Adhesive and other UV curable adhesives and even adhesion via metallization, vapor-deposited polymers and electrochemical polymerization of coating materials.

In one embodiment, the adhered tip is coated with surfactant and a polymeric material such as PEG to preclude non-specific binding. This coating may be the same material used to increase adhesion of the nanotube to the supporting substrate or separate material or materials used in sequence or combination. The coating can be either chemisorbed or physisorbed onto the tube. For purposes of the instant patent application, the term “chemisorbed” refers to formation of a covalent bond between the nanotube and the coating.

The formation of a covalent bond can alter the electronic properties of the nanotube. In accordance with a preferred embodiment, the coating layer will be physisorbed onto the nanotube. For purposes of the instant patent application, the term “physisorbed” refers to formation of other than a covalent bond between the nanotube and the coating.

Examples of coating to achieve specific purposes include surfactants, polymers, resists, metals, electrochemically deposited metals, polymers, or semiconductors. One or more layers of any of these materials can be applied in succession.

The nanotube tip is then shortened, most commonly through application of a short voltage pulse, to a length suitable as a scanning probe. This length is typically less than 500 nm, and may be less than about 250 nm. In another embodiment, this length is less than about 200 nm and may be less than about 100 nm. In still other embodiments, this length is less than about 100 nm, may be less than 50 nm, and can be as short as about 10 nm.

Application of an electrical pulse, while the coated nanotube tip is in contact or near contact with a grounding substrate, is made to remove coating used to inhibit non-specific binding at the very tip. In one case this material may be a surfactant/PEG solution. This is accomplished through ablation and/or oxidation of the remaining tube end. When performed in an oxidizing environment, the exposed carbon nanotube tip is chemically functionalized with a carboxyl (COOH) group. When performed in a nitriding environment, the exposed carbon nanotube tip is chemically functionalized with an amine (NH₃) group.

A specific sensing material can be attached to the end of the nanotube at this unique location. This can be accomplished through covalent chemical bonds to the carboxyl or amine groups at the free end of the nanotube.

Alternately, this attachment can be accomplished via physisorption to the end of the tip. Physisorption could be carried out either by dipping it in the desired material or by touching the end on a very thin deposit of the desired material and lifting off a small deposit at free end of the nanotube. The very thin layer could be created by many commonly known techniques such as spin coating or dip pen lithography.

Alternately, the properties of the nanotube coating material can be electrochemically altered via application of the electrical pulse in different ways than ablation or oxidation, such as reduction. Alternately, several coating of materials could be applied sequentially to gain specific sensing capabilities.

In one specific example of this invention, the adhered nanotube could be coated with metal. In another example of this invention, the nanotube could be coated with several metal layers. In some cases, these metal layers are coated with an insulating material such as a nonconductive polymer. Ablation or oxidation of the end will leave an exposed ring or tip of metal and carbon while protecting the insulating qualities of the assembly.

Differential functionalization is achieved at the free end of the nanotube. It could be achieved through physisorption or chemisorption of a different polymer layer than the initial coating layer or layers. Or it could be achieved by electrochemically altering the coating first applied. Or metal could be localized at tip through resist ablation at tip, metallization, lift-off in acetone, etc. Alternately, the bare tip could be used directly as a nanoelectrode.

FIG. 2 shows a simplified flow chart of process 200 employing basic techniques for creating nanoscale or single molecule sensors, manipulators, and devices. In first step 202 described in detail below in Section 1., a nanotube is attached to an AFM tip.

In a second step 204 described in detail below in Section 3.A., a nanotube may be adhesively bound to an AFM tip utilizing UV curable adhesive, epoxy or other adhesive. In a third step 206 described in detail below in Section 3.B., the nanotube may be coated with one or more layers to preclude non-specific binding or interactions with another material, and/or electrically isolate the nanotube from the surrounding environment. Examples of passivating coatings for use in accordance with the present invention include, but are not limited to a surfactant, a polymer, a resist, an evaporated metal, an electrochemically deposited metal, and a semiconductor. In some cases a coating will also serve to increase the adhesion between the nanotube and its supporting substrate.

In a fourth step 208 described in detail below in sections 3.B.-3.D., the tip may be differentially functionalized utilizing a number of techniques, alone or in combination. For example, functionalization may be accomplished through use of (1) different absorbed polymer, (2) covalent chemistry to exposed and oxidized NT tip; (3) electrochemical alteration of coating layers, (4) metal localized at tip by resist ablation at tip; or (5) metallization followed by resist lift-off in acetone.

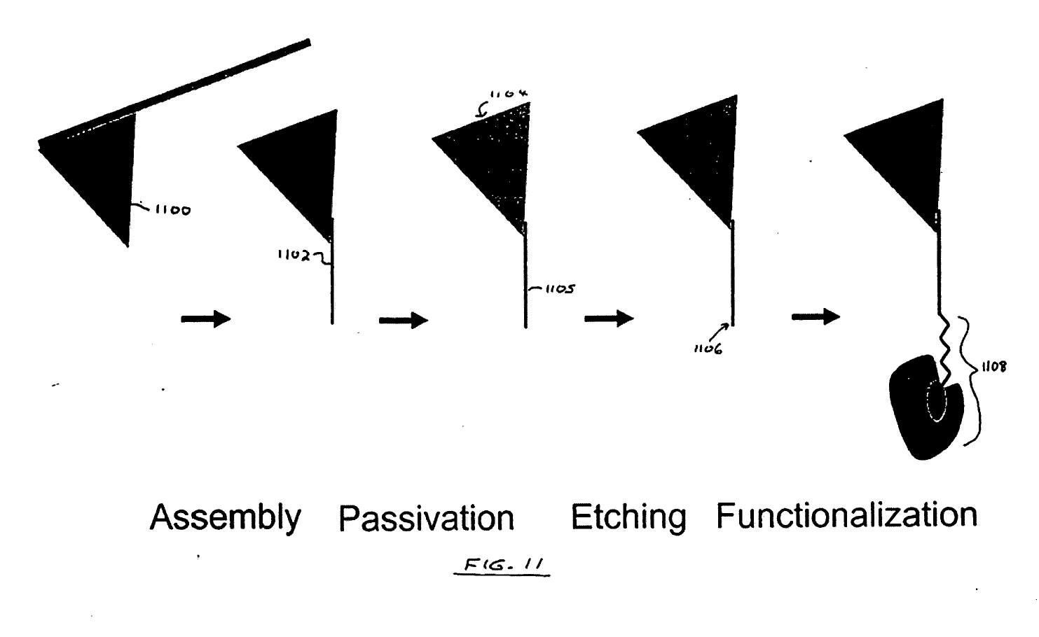

FIG. 11 shows simplified schematic views summarizing the process of wiring biomolecules to carbon nanotube scanning probes in accordance with embodiments of the present invention. In a first stage, the probe is assembled by causing the AFM tip 1100 to pick up nanotube 1102. In a second stage, the assembled probe 1104 is passivated with material 1105. In a third stage, tip 1106 of the assembled probe exposed by etching. In a fourth stage, the probe is functionalized by interaction between the exposed probe tip and a chemical species 1108. A single sensing assembly comprising one or more molecules is then attached at this uniquely functionalized site and used to probe or sense a variety of samples.

1. “Pick-up of individual SWNTs from Flat Substrates

We have found the most success in our labs in following the procedure of growing individual SWNTs on flat surfaces, and using the silicon probe tip to pick up vertically oriented tubes during imaging of these substrates in tapping mode. As described by Wade et al., “Correlating AFM Probe Morphology to Image Resolution for Single-Wall Carbon Nanotube Tips”, Nano Lett., 10.1021/nl049976q (2004), incorporated by reference herein for all purposes, both the growth conditions of SWNTs as well as the conditions for mounting them on AFM probes with the optimal geometry, are more controllable and better defined with this approach.

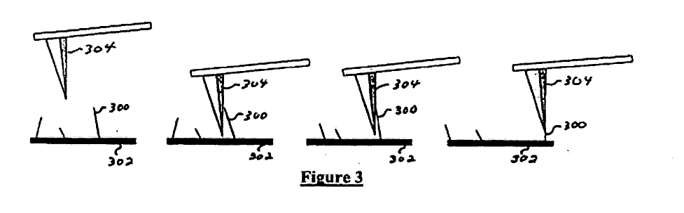

FIG. 3 shows a simplified schematic view of the pick-up attachment of SWNTs 300 grown on substrate 302. The as-grown nanotubes can be attached to a scanning AFM probe 304 by van der Waals forces. Once the SWNT has become attached to the AFM tip, the bond between them can be reinforced by gas phase polymerization coating in a plasma reactor, electrochemically deposited coatings, metallization, or curing of a precoated adhesive such as epoxy.

To contrast the relative yield between the pickup and direct catalyst growth methods: in one week we have picked up and shortened 20 SWNT AFM tips to between 10 and 25 nm in length. Estimates for optimal production of direct catalytic tube growth on tips are only 1 useful tip per 2 days, for a dedicated researcher with complete co-located facilities, as described by Wong et al, “Carbon Nanotube Tips: High Resolution Probes for Imaging Biological Systems”, J. Am. Chem. Soc. 120, 603-604 (1998), incorporated by reference herein for all purposes.

Van der Waals forces between the silicon apex and the picked-up SWNT are believed to hold the nanotube to the tip firmly in air. For imaging in fluids, the silicon pyramidal apex could be pre-conditioned by applying an adhesive to the tip before pick-up followed by curing (with a UV lamp for example). Alternately, evaporative metallization may be an effective tool for strengthening of the attachment site while still preserving the conductive properties of the SWNT tips. Further alternately, plasma deposition of a polymer may be an effective tool for strengthening of the attachment site while still preserving the conductive properties of the SWNT tips.

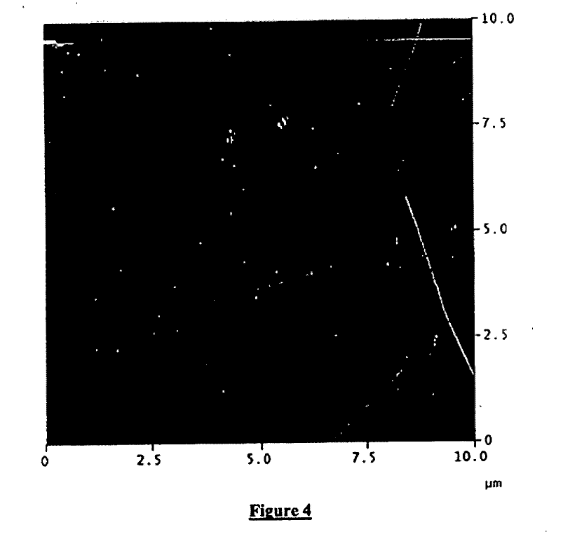

The primary indication used to tell that a SWNT has been picked up during imaging, is a step change in the Z height. Once a SWNT has been picked up and shortened, the probe can be transferred to a sample for high-resolution imaging, biomolecular manipulations, or force spectroscopy. As evidenced by the large number of SWNTs shown in FIG. 4, the same SWNT substrate can be used thousands of times to prepare SWNT AFM tips easily and reliably.

A. CVD Growth of SWNTs on Pick-Up Substrates

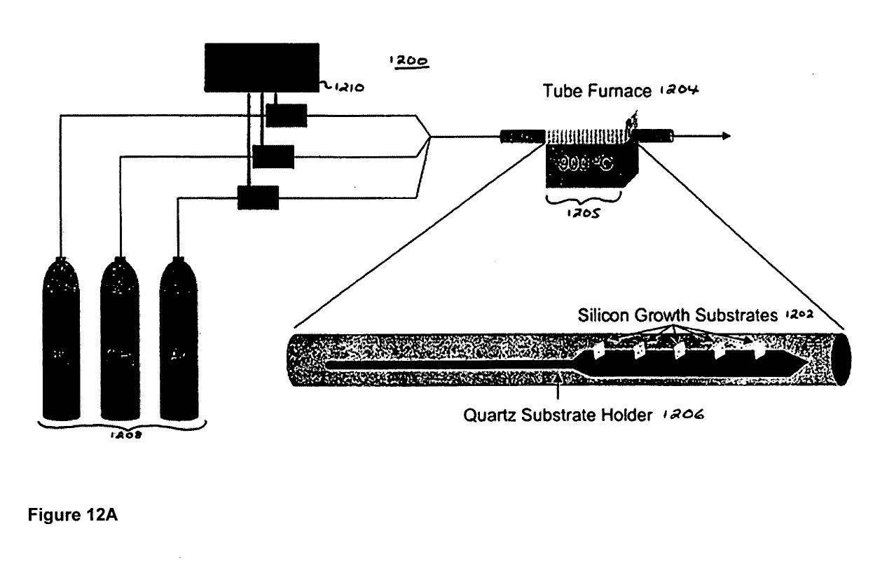

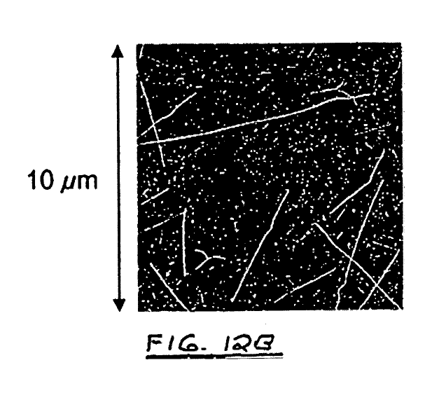

FIG. 12A shows a schematic view of an apparatus 1200 for achieving SWNT catalyzed vapor deposition growth. Growth of SWNTs is carried out by CVD on square 500 μm thick Si/SiO₂ wafers 1202 with dimensions between 4 mm and 8 mm.

The wafers are first coated with an iron catalyst by spin-coating at 3000 rpm with 12 drops of a 100 μg/ml solution of Fe(NO₃)₃.9H₂O in isopropyl alcohol. Alternatively, the concentration of Fe(NO₃)₃.9H₂O may range from between about 5-30 μg/ml. Between applications of each drop of catalyst solution, the wafer is spun for several seconds to allow the solvent to evaporate. Catalyst deposition is preferably, though not necessarily, carried out in a clean room.

Alternately, catalyst deposition of metals such as iron, nickel and iron-nickel can be carried out using sputtering, thermal evaporation, molecular-beam epitaxy (MBE). Alternately proteins such as Ferritin can be used to deposit iron catalytic sites uniformly. Alternately nickel-based catalysts can be used on unoxidized silicon substrates.

CVD is performed in a 22 mm inner diameter Lindberg/Blue M quartz tube furnace 1204 with a heating zone 1205 that is 312 mm long. Five wafers are positioned 12.5 mm apart in a specially designed quartz holder 1206, oriented vertically and with the catalyst coated side facing away from the direction of the incoming gas from sources 1208 regulated by mass flow controller 1210. The most rapid nanotube growth is obtained when the holder is positioned at the leeward end of the quartz tube, with the last wafer approximately 2 mm from the end of the heating chamber/zone.

The quartz tube is then flushed for 15 minutes with argon gas (Matheson, 99.9995% purity, 440 sccm). The furnace is heated at 950° C. for approximately 20 minutes, and then held at 950° C. for 15 minutes, both under a flowing atmosphere of Ar (440 sccm) and H₂ (Matheson, research grade, 125 sccm). The furnace is held at this temperature for 5 additional minutes while being flushed with Ar (440 sccm). Growth of nanotubes is then carried out for 1-5 minutes at 950° C. with CH₄ (Air Liquide, Ultra High Purity, 1080 sccm) and H₂ (125 sccm).

Following this growth step, the furnace is again flushed with Ar (440 sccm) and held at 950° C. before rapidly cooling to less than 250° C., after which the substrates are exposed to air and removed from the furnace. FIG. 12B shows a scanning electron micrograph of SWNTs grown on a pick-up substrate.

This procedure is offered as an example of one of the many which we have used to grow nanotubes. There are many available variations in gas mixture, growth temperature, mass flow rates and procedure step times.

2. SWNT Pick-Up and Shortening Procedure

The growth procedure generates SWNTs on the substrate with diameters ranging from 1.6 to 3.0 nm, and lengths between 100 nm and 5 μm, as imaged with SEM and TEM. Most of the tubes are oriented horizontally with respect to the substrate surface, and can be imaged with standard AFM.

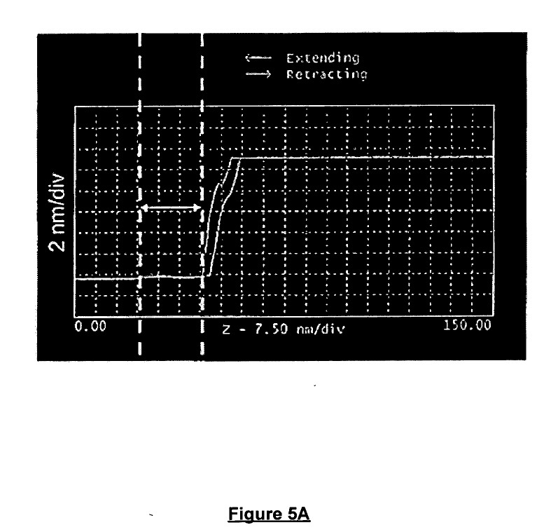

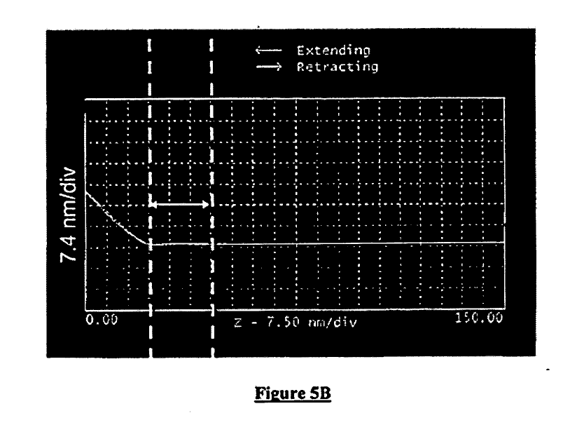

The results from a typical growth are depicted in FIG. 4, which shows a micrograph of SWNTs grown by CH₄/H₂ CVD on a pick-up (Si/SiO₂) substrate. This image, and the force spectroscopy curves displayed below in FIGS. 5A-B were taken with a MultiMode AFM instrument in Collier's lab, controlled by a Nanoscope IV controller, both from Digital Instruments of Santa Barbara, Calif.

A small percentage of tubes are oriented vertically, and can be picked up by scanning the AFM cantilever across the surface. Typically, 1 to 4 tubes can be picked up from a 10 μm×10 μm square region. The tube binds to the side of the pyramidal AFM tip through Van der Waals attractive forces, and usually remains attached firmly enough that it can be repeatedly pressed into or scanned across the substrate surface. The pick-up of a nanotube is readily observed by monitoring the Z height while looking for a significant step change in the average position.

In almost all cases, more than 100 nm of nanotube protrudes from the end of the AFM tip, making high resolution imaging impossible due to thermal fluctuations and bending without first shortening the tube to lengths between 10 and 100 nm for a 2 nm diameter SWNT. The length of the nanotube protruding from the end of the AFM tip can be measured indirectly by observing the oscillation amplitude and deflection of the cantilever as it is brought into contact with a hard surface.

Consider first the profile of a bare tip in contact with a substrate. As the approaching tip begins to interact with the surface, the oscillation amplitude decreases quickly, reaching zero when the tip is in full contact. At this point of contact, the cantilever deflection signal begins to rise linearly as the tip is pressed further into the surface.

A tip with a protruding nanotube will show a different profile, as depicted in FIGS. 5A-B, which plot oscillation amplitude and cantilever deflection signals, respectively, for an AFM tip with a SWNT shortened to about 22 nm. In FIGS. 5A-B, the length of the tip is depicted by the length between the two vertical dashed lines.

The oscillation of the tip undergoes rapid damping as soon as the nanotube makes contact with the surface. However, the SWNT buckles elastically at higher loads and does not deflect the cantilever.

Only when the rigid Si tip apex itself makes direct contact with the substrate is the deflection detected. The distance between the point at which the oscillation amplitude decreases to zero and the point at which the deflection of the cantilever is detected indicates the protrusion length of the nanotube. In this region, the tube is elastically bending or buckling, which is reversible: when the probe is retracted, the buckled tube can reform to its original shape.

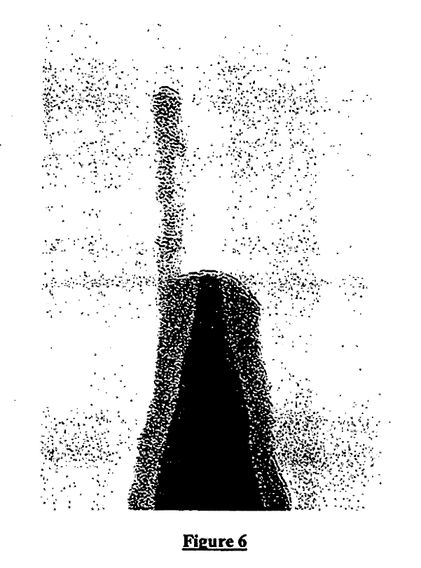

FIG. 6 shows TEM image of shortened nanotube at the end of a silicon AFM cantilever tip. This tip was attached via the pickup method and shortened to 65 nm using electrical pulses as described above. The diameter of this tip is approximately 6 nm. Due to the structure at the end of the nanotube and the angle at which it is mounted relative to the surface, it images with a resolution of approximately 3 nm.

The procedure to shorten the SWNT in air comprises applying +3 to +50 volt pulses of 20 to 100 μs duration between the AFM tip and a grounded, conductive silver substrate. These pulses are supplied from a Hewlett-Packard 8114A pulse generator and routed to the tip through a Digital Instruments Signal Access Module, or “break-out” box, which is connected to the MultiMode AFM. Presumably the nanotube is shortened by ablation resulting from the very high electric field generated at the nanotube end. The pulses are applied while tapping the surface at approximately 70-300 kHz, which is near the resonance frequency of the cantilever.

For a given SWNT tip, larger voltage pulses shorten the tube in larger increments, as do pulses of longer duration. But the voltage necessary to carry out shortening varies drastically between individual tubes. This is believed due to the widely varying conductivities associated with nanotubes of slightly different molecular structure, for example, between semiconducting and metallic nanotubes.

Nanotubes can be shortened precisely with steps as small as 2 nm per pulse. The main drawback to this technique is that the electrical pulsing can dislodge the nanotube electrostatically from the AFM tip. However, this effect can also be exploited to controllably deposit nanotubes precisely on substrates for device fabrication.

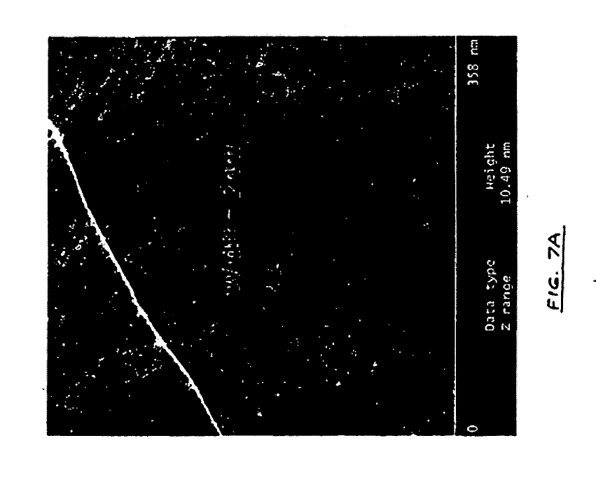

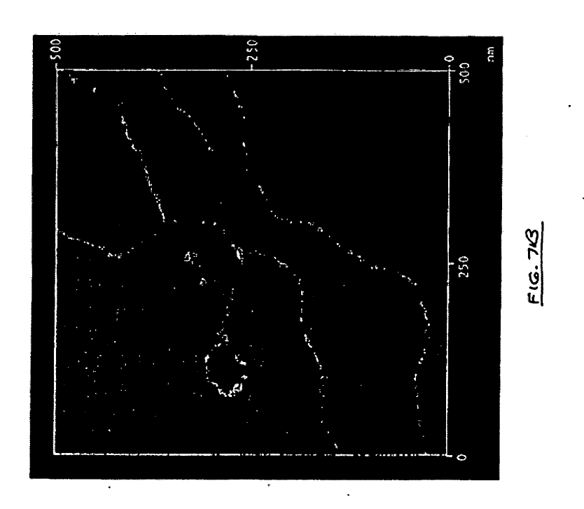

FIG. 7A shows AFM images of SWNTs on oxidized silicon substrate taken using a shortened pickup nanotube tips grown by our team. The SWNT AFM images seen in FIG. 7A determine the equivalent resolution that we have been able to obtain so far to be 0.5 nm.

The resolution is defined as being the difference between the measured height of the cylindrical nanotube and the width at the noise floor. In this case the 1.6 μnm diameter nanotube was measured to have a 2.1 nm width at the noise floor. Hence the very conservative estimate of 0.5 nm resolution. Typical silicon tips are 10-30 nm in diameter. AFM resolution in the X-Y plane is proportional to the tip radius. The resolution seen here is ˜20-30 times better than can be achieved with a conventional silicon tip.

FIG. 7B shows AFM images of DNA on mica taken using a shortened pickup nanotube tips grown by our team.

3. Functionalization of SWNT AFM Probes

A. Adhesion of Picked-Up SWNT to AFM Tip for Operation in Liquids

If necessary, the silicon apex of the AFM tip can be pre-coated with a very thin layer of an adhesive (for example Norland Optical Epoxy Number 60) before picking-up a SWNT from the growth substrate. This involves bringing the AFM cantilever assembly mounted on a XYZ micromanipulator into contact with a very thin layer of adhesive. The neck of a drawn-out filament from a bead of epoxy coated on a wooden applicator has been found to be a sufficiently thin coating. The process is performed under 10× to 110× magnification in a stereo zoom microscope.

Once a SWNT has been picked up from the substrate by the scanning AFM, the adhesive is cured. In the case of the Norland optical adhesives, this is accomplished with a UV lamp. The bulk resistivity of the optical epoxies is high but the layer can be thin enough to allow sufficient electrical contact between the silicon AFM tip and the nanotube.

Other adhesives, with lower resistivities, will enable improved electrical contacts to be achieved. Curing of the adhesive can be accomplished either after pickup and before pulse shortening, or after pickup and shortening are completed. Alternatively, polymer or metal coatings can be applied after pickup to improve adhesion.

B. General Description of Differential Functionalization of SWNT Tips

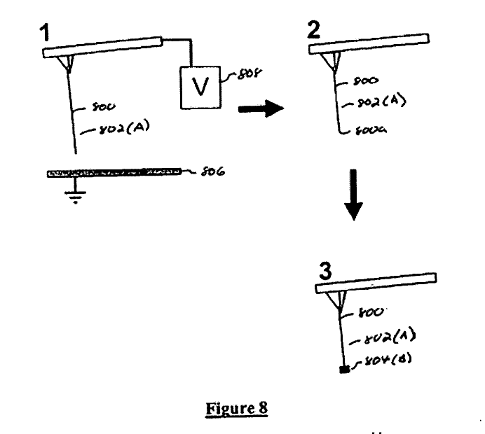

The as-grown SWNT can be coated with one, two, or many different materials depending on the specific embodiment envisioned. FIG. 8 shows a simplified schematic view of the basic process flow for unique functionalization of the free end of a nanotube 800. The process starts with coating with a material 802 that inhibits non-specific binding. In the second step, an electrical pulse is then used to ablate or vaporize the end of the tube exposing the tip 800a. The tip can then be uniquely functionalized, as shown in the third step.

In the embodiment shown schematically in FIG. 8, the process uses a single initial coating, A, (802) which can then be modified with the application of a potential difference between the AFM tip and the scanned surface to give coating layer B, (804) having fundamentally different chemical, biological and/or physical characteristics. Depending on the particular embodiment, the voltage may be of any magnitude, polarity and duration. In the embodiment shown in FIG. 8, the probe tip is positively charged relative to grounded conductive substrate 806 as a result of connection with voltage pulse generator 808.

The high electric field density between the SWNT tip and the surface will localize the physical extent of layer B to, at most, a few nanometers from the resulting tip end. Specific examples of changes in the characteristics of layer B relative to layer A will depend on the details of the specific embodiment envisioned and may result from procedural steps carried either before, during or after the application of the electrical potential.

The role of the electrical event in any process will be to either ablate material from the tip of the SWNT probe, possibly including but not limited to the nanotube core, or electrically/electrochemically change the nature of the initial coating formulation at the tip relative to the rest of the tube due to the vastly increased density of electric field lines emanating from the sharp tube end.

The modification will involve charge injection at the region of modification, and may or may not be accompanied by measurable electrical current. The electrical modification process may be monitored in real time by correlating measurements of the voltage difference between tip and surface or current flow between the two, with observation of tip oscillation amplitude or tip deflection similar to the description of tube shortening in section 2 above.

C. Specific Embodiments of SWNT Functionalization and Applications

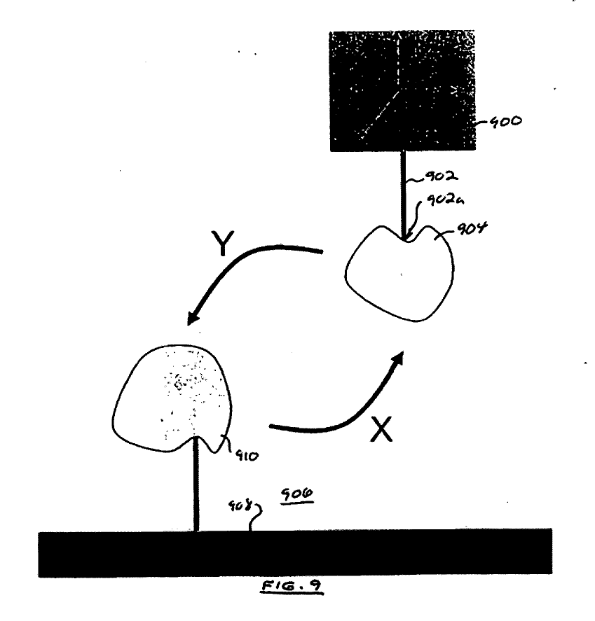

In one general class of modifications, SWNTs attached to AFM probes can be functionalized to serve as single molecule manipulation and sensing devices. FIG. 9 shows a simplified schematic view of such an embodiment, wherein AFM probe 900 includes nanotube 902 functionalized to bear molecule 904 at its tip 902a. AFM tip 900a may be translated along the x-, y-, or z-axes to bring molecule 904 into proximity with environment 906 (here represented as surface 908 bearing feature 910). Based upon interaction (X/Y) between the probe and the environment, control of biomolecular dynamics at the molecular scale may be accomplished utilizing techniques such as single-molecule manipulation, single-molecule fluorescence, or electrochemical triggering of biochemical reactions. In addition, kinetics of chemical or biological activities may be monitored, controlled, triggered, or catalyzed by such devices.

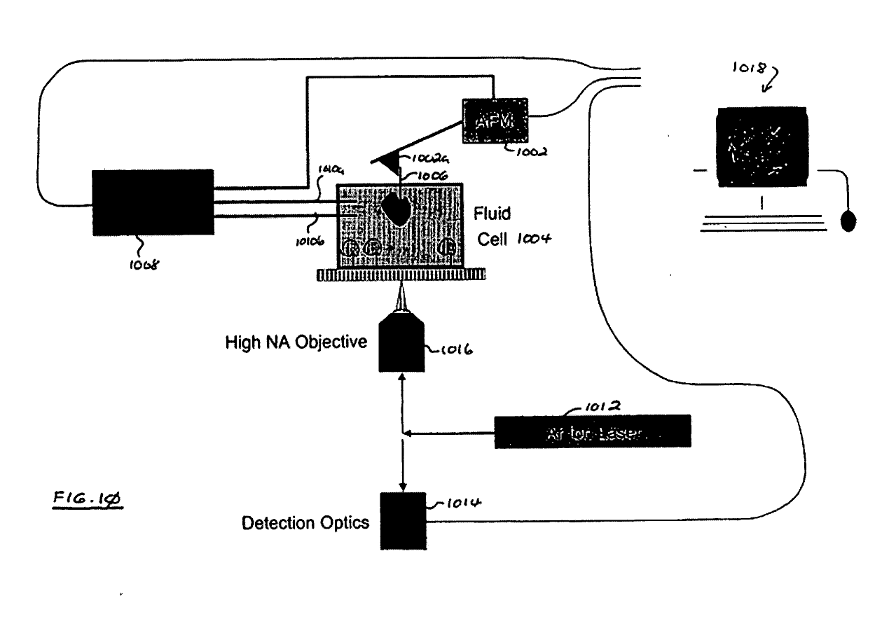

FIG. 10 shows a simplified schematic view of one embodiment of a hybrid AFM/optical microscope utilizing functionalized SWNTs. Device 1000 comprises atomic force microscope (AFM) 1002 having probe 1002a, in fluid communication with fluid cell 1004. Probe 1002a bears nanotube 1006 bearing functionalized end 1006.

Fluid cell 1004 is in electronic communication with potentiostat 1008 through electrodes 1010a and 1010b. Fluid cell 1004 is in optical communication with light source 1012 (e.g. an Ar Ion laser) and detection optics 1014 through high NA objective 1016. Computer 1018 is in electronic communication with the AFM, potentiostat, and detection optics.

Such SWNTs attached to AFM probes can be functionalized as single molecule manipulation and sensing devices using a three-step procedure.

A first step involves initial coating to ensure that non-specific binding is inhibited. In certain embodiments, the initial coating step on the SWNT may take place while the tube is still on the growth substrate, before it is picked up by the AFM tip.

An initial coating formulation that has been shown to effectively resist non-specific binding of molecules such as proteins to SWNTs involves co-adsorption of a neutral surfactant such as Triton-X 100 and PEG. Triton is surfactant containing a hydrophobic aliphatic chain, terminated by a short hydrophilic PEG group. Binding of Triton to SWNTs is favorable due to hydrophobic interactions and has been a well-used method for preparing stable suspensions of SWNTs in aqueous solutions.

Like many other polymers, PEG can be irreversibly adsorbed onto SWNTs. However, coating of SWNTs by Triton-X or PEG alone does not result in complete passivation of the SWNT; both materials are needed for uniform passivation of the nanotube.

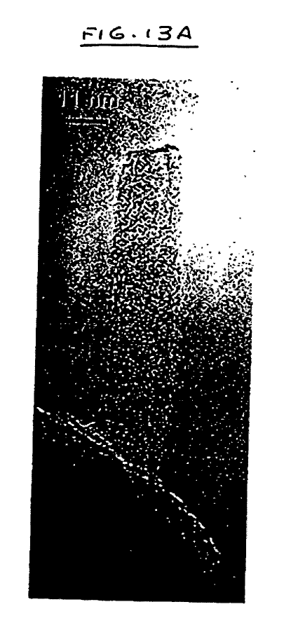

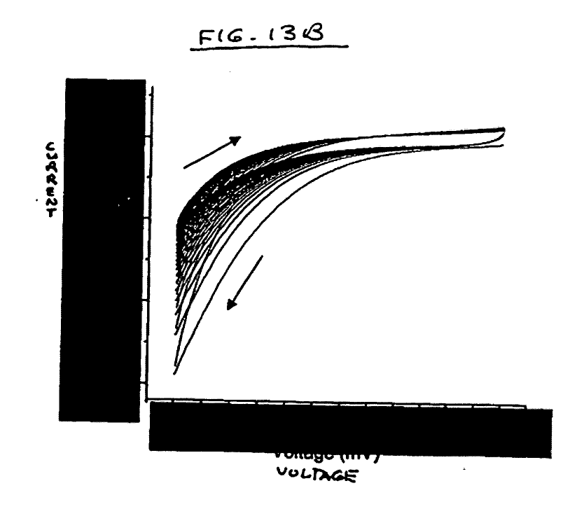

Alternatively, or in conjunction with forming passivation through exposure to surfactant(s), a passivation layer can be formed over a SWNT utilizing an electrochemical polymerization process. In accordance with one embodiment of the present invention, a SWNT may be passivated with a phenylenediamine polymer resulting from electrochemical oxidation of phenylenediamine monomer. FIG. 13A shows an electromicrograph of a SWNT passivated in this manner.

FIG. 13B is a cyclic voltammetry plot taken during formation of the passivated SWNT shown in FIG. 13A. The reduced current (y-axis) at later cycles reveals the reduction in conductivity of the SWNT, and hence the thickness/strength of the passivation layer formed.

i. Plasma Coating and Functionalization of SWNTs

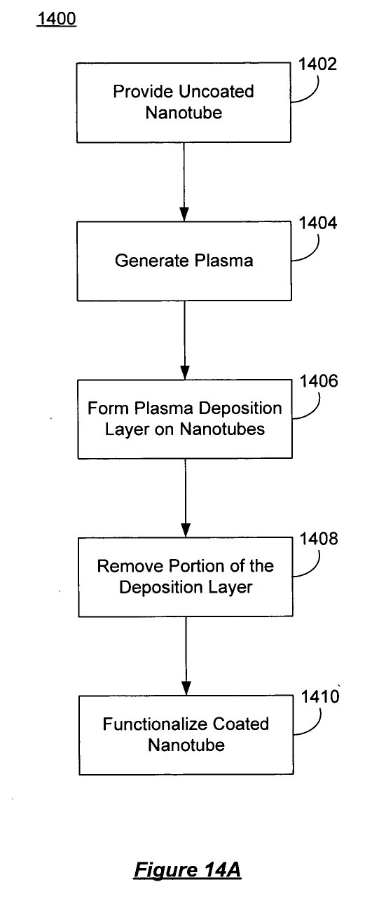

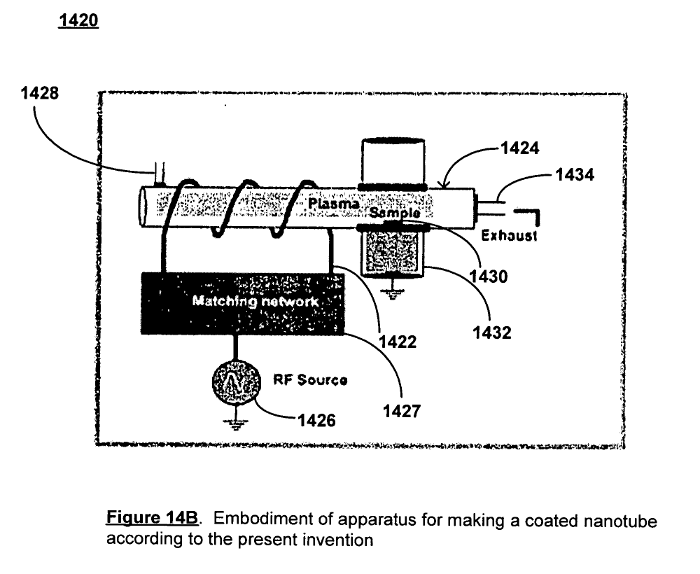

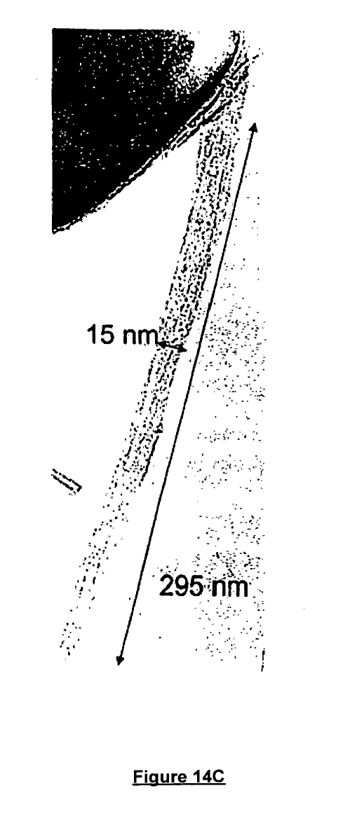

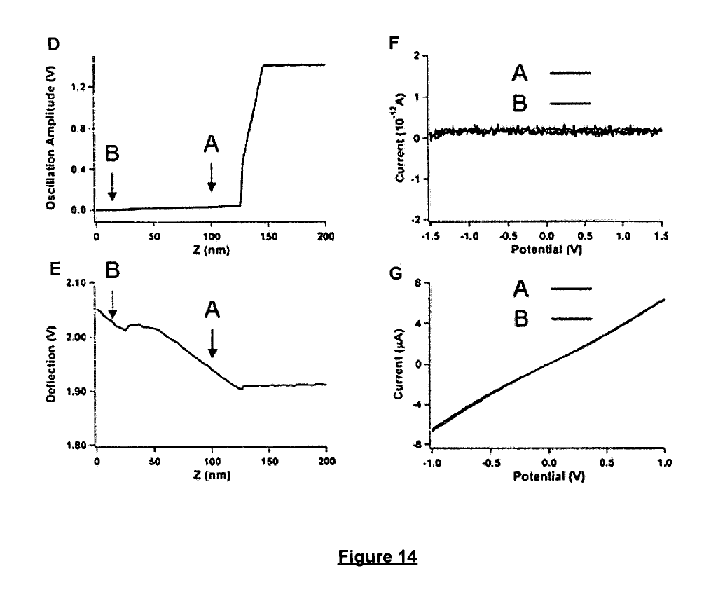

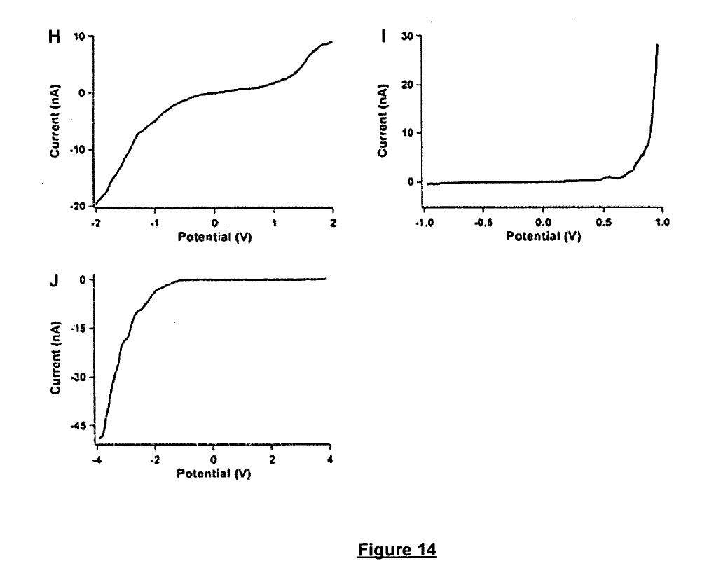

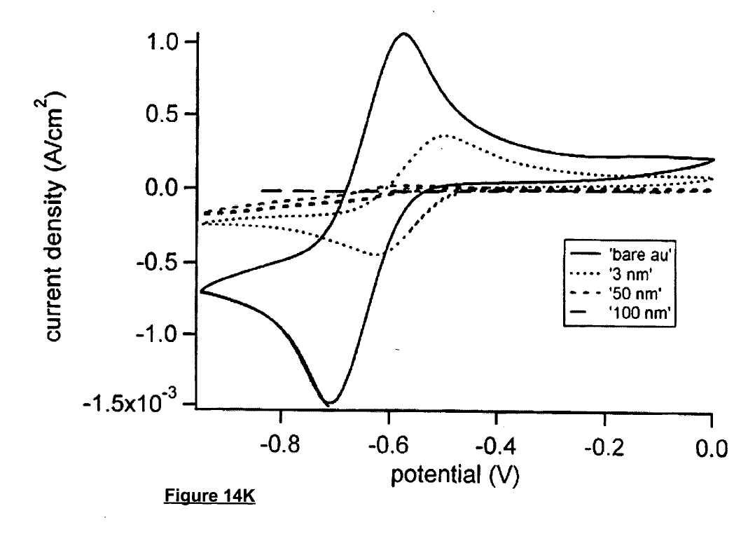

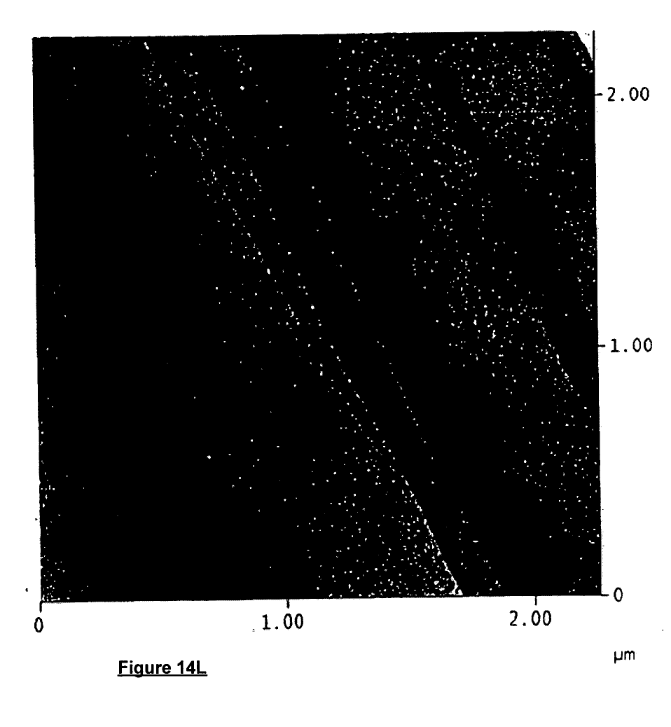

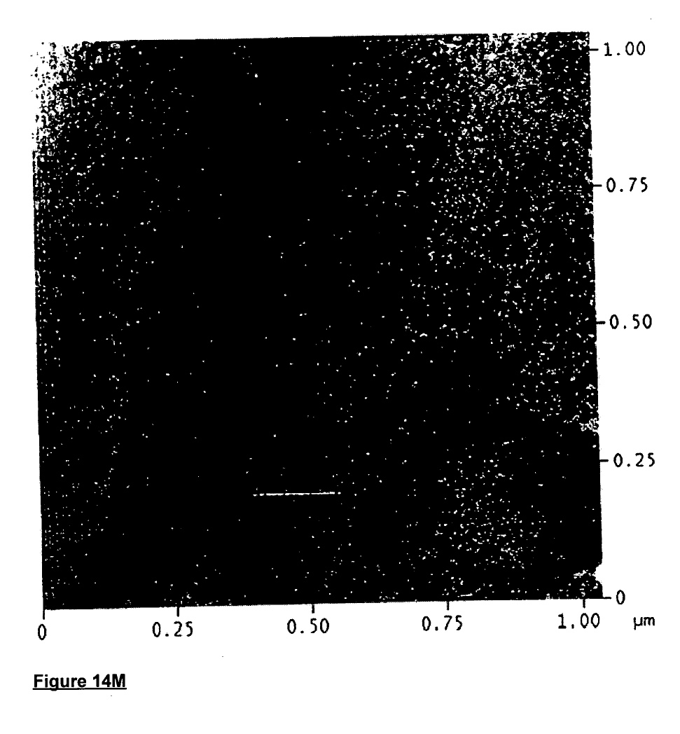

Moreover, passivation of a SWNTs is not limited to exposure to surfactants or electropolymerized materials as just described. In accordance with still other alternative embodiments of the present invention, a passivation layer may be deposited by gas phase polymerization. For example, FIG. 14 shows the steps in a method 1400 of making nanotubes coated with a plasma deposition layer according to embodiments of the invention. The method may include providing the uncoated nanotubes 1402 to a plasma reactor for the coating process. The uncoated nanotubes may be single-walled carbon nanotubes (SWNTs) made on CVD growth substrates as described in FIGS. 12A and B above. In some embodiments, the apparatus used as the plasma reactor for coating the nanotubes may also be used to grow the uncoated nanotubes. In additional embodiments, the inner nanotubes are formed in a separate CVD apparatus (like the one shown in FIG. 12A) and the silicon growth substrate 1202 containing the nanotubes transferred to a separate plasma reactor.

Once the uncoated nanotubes are provided to the plasma reactor, either by in situ generation or being transferred from another apparatus, a plasma is generated 1404 to provide the starting materials for forming a plasma deposited layer on the uncoated, inner nanotubes. The plasma may be generated through an inductively-coupled plasma generation process at relatively low power (e.g., about 50-75 Watts). The uncoated nanotubes may be located at the plasma generation site, or at a downstream location in the reactor. When the plasma generation and nanotube sites are separate, a portion of the plasma traveling downstream from the plasma generation point eventually contacts the nanotubes and forms a plasma deposition layer 1406 on the exterior surface of the uncoated nanotube. Downstream deposition of the plasma results in fewer fast ions and radicals bombarding the nanotubes. Ion bombardment may also be reduced by grounding the substrate that has the nanotubes.

After the plasma deposition layer has been formed, a portion of the layer may be removed 1408 to expose the underlying inner nanotube. Removal may be accomplished by contacting the coated nanotube to a conductive material, and running an electrical current between the inner nanotube and the conductive material, which can ablate off a portion of the plasma deposition layer in the path of the current. For example, a coated nanotube may be attached to the apex on a tip of an AFM, and the distal end of the coated nanotube put in contact with a conductive medium such as liquid mercury (Hg). Electric current passing through the AFM tip to the mercury can ablate the portion of the coating in contact with the mercury, leaving the distal end of the inner nanotube exposed. Removal may also be done using a beam of light to ablate off the deposition layer (e.g., laser ablation), or chemically etching the coating.

The exposed portion of the coated nanotube may be functionalized 1410 to detect a selected chemical or class of chemicals, biological agent, etc. This functionalization may include forming a material over the exposed inner nanotube, where the material changes a measurable property (e.g., electrical resistance) of the coated nanotube when it comes in contact with a selected analyte (e.g., chemical and/or biological compound). The material may be highly sensitive to the analyte, and produce a detectable change in the nanotube upon contact with a single molecule of the selected analyte.

FIG. 14B shows a plasma reactor 1420 according to an embodiment of the invention. The plasma reactor 1420 has coils 1422 wrapped around one end of chamber 1424 to supply RF power to the reactor 1420 for generation of an inductively-coupled plasma. An RF power source 1426 supplies power to the coils 1422. A π-network matchbox 1427 may be coupled between the RF power source 1426 and the coils 1422 to ensure precise impedance matching.

Plasma precursor materials, such as argon and fluorocarbons, may be supplied to the reactor at precursor inlet 1428, and converted into plasma at the plasma generation location. The plasma may travel downstream from the generation location to a substrate 1430 containing the uncoated nanotubes, where the plasma deposition layers are formed on the nanotubes. The nanotube substrate 1430 may be placed on a grounded electrode 1432 that is connected to the same voltage ground as the RF source 1426. An exhaust outlet 1434 connected to a vacuum pump (not shown) may be positioned downstream from the substrate 1430 to remove used plasma precursors and other exhaust products from the chamber 1424.

Embodiments of the method 1400 and reactor 1420 described in FIGS. 14A-B may be used for producing a variety of coated nanotubes. For example, experiments were conducted to generate Teflon-like fluorocarbon layers on single-walled carbon nanotubes (SWNTs) according to embodiments of the invention. The SWNTs were grown by chemical vapor deposition on either bare silicon AFM tips (e.g., FESP, NanoDevices, Santa Barbara, Calif.) or gold-coated tips (e.g., 50 nm Au onto 10 nm Cr) using the pick-up technique. The length of the protruding nanotubes was variable, ranging from 40 to 350 nm, with an average diameter of 5 nm. The total length of the SWNT probe was roughly equivalent to the length of just exposed regions of a Parylene-coated MWNT probe.

A reactor assembly that used to coat the SWNTs included a 6-way Pyrex glass chamber (Inner Diameter=100 mm) having an upstream extension tube for accommodating a 4-turn copper tube antenna coiled around the glass-walled cylindrical extension. Power was supplied to the antenna from a 600 W variable radio-frequency amplifier driven by a sinusoidal waveform at 21 MHz. The power output ranged from about 50 to about 75 Watts. A conventional π-network matchbox was used to ensure impedance matching. The reactor was supplied with argon (Ar) and octafluorocyclobutane (C₄F₈), premixed with separate mass flow controllers at predetermined flow rates. Conformal fluorocarbon deposition layers were achieved using 7 sccm Ar, and 1.5 sccm C₄F₈ with the reactor pressure being about 160 mTorr. A dopped silicon nanotube substrate sitting on a polished aluminum electrode downstream from the plasma generation site was exposed to the fluorocarbon plasma for about 60 to 90 seconds to form the coating on the nanotubes.

FIG. 14C shows an electron micrograph (i.e., TEM image) of a coated nanotube generated in the experiments above taken with a Phillips EM430 microscope operating at 300 kV. The coated fluorocarbon coated SWNT measured about 80 nm in length and about 15 nm in diameter. The diameter of the inner SWNT typically range from about 0.7 to about 6 nm (more typically about 1.6 to 3 nm), and the lengths of the nanotubes are typically greater than 50 nm (more typically, about 40 nm to 350 nm). The fluorocarbon layer enhances a number of characteristics of the nanotube, including enhanced chemical inertness and insulating properties, increased rigidity, and enhancements of the abilities of the tubes to be selectively functionalized. The adhesive qualities of the fluorocarbon layer can also reinforce the attachment of the nanotube to an AFM tip without using additional adhesive compounds. These an other enhanced characteristics imparted by the fluorocarbon layer may the coated nanotubes good candidates for chemical and biological sensors in gas and liquid environments, and probe tip components for AFM, among other applications.

Fluorocarbon layers were also deposited on flat surfaces of silicon (100), polycrystalline Au, and highly oriented pyrolytic graphite (HOPG) for surface analysis and electrochemical studies. The silicon and Au surfaces were model surfaces for the AFM tips used, while the HOPG surfaces were taken as an approximation to the carbon nanotubes. Film morphology, composition, thickness, and electrical and mechanical properties were evaluated by a number of different techniques: AFM, TEM, ellipsometry, XPS (X-ray photoelectron spectroscopy) and electrochemical impedance spectroscopy.

Film thicknesses were determined by XPS and ellipsometry, which gave mutually consistent results. AFM measurements of coated HOPG substrates indicated that the film growth was highly conformal, reproducing the underlying step-terrace topography of freshly cleaved graphite. For thin polymer films (thickness less than 30 nm) the root-mean-squared surface roughness values on silicon, gold and HOPG did not change from those of the uncoated surfaces, while for thicker films, the surface roughness of the coating increased slightly. XPS measurements showed that the composition of the film could be controlled by fine tuning the plasma operation. The plasma operating conditions were adjusted so that the CF₂ component had the highest intensity in the XPS spectra, consistent with a more Teflon-like polymer. Electrochemical impedance spectroscopy gave 8.5×10¹¹ Ω·m for the resistivity and 2.3 for the dielectric constant of these films. The dielectric constant falls within the range reported for fluorocarbon polymers (2.1 to 2.6). Although the thin-film resistivity is lower than the volume resistivity reported for bulk Teflon (˜10¹⁶ Ω·m), it is important to note that these films were less than 30 nm thick. TEM images like FIG. 14C showed that the fluorocarbon coatings were deposited uniformly and conformally on nanotube AFM tips.

The coatings significantly enhance the mechanical strength of SWNT probes. We have used coated SWNT tips that are hundreds of nm long to image prone SWNTs on the growth substrate in tapping mode. The lateral resolution of the images (full width minus height) was equal to the width of the probe as measured by TEM. Imaging with uncoated SWNT probes having these lengths would be virtually impossible due to their lateral flexibility, which leads to severe artifacts from buckling and bending instabilities.

The electrical insulating properties of the polymer coatings were characterized using tapping mode AFM as the probe came into contact with a small (less than 200 μm) drop of liquid mercury. The procedure we used is similar to conventional procedures for measuring conductive properties of uncoated SWNT tips, except we measured the conductive properties of the coated nanotube probe both before and after the probe end had been exposed by electrical pulse etching. The AFM was shielded using a Faraday cage. The coated nanotube probe was placed in an electrostatic force microscopy (EFM) tip holder, which allowed the direct application of potentials to the tip in combination with a Digital Instruments signal access module. A computer data acquisition card was used to generate steady-state voltages for monitoring the tip conductivity and generating current-voltage (I-V) curves. For electrical pulse etching, an HP 8114A pulse generator was used.

The nanotube tip was first engaged in tapping mode on the surface of the Hg droplet. The AFM controller was then immediately switched to tapping mode force calibration, which consists of monitoring the cantilever oscillation amplitude and deflection as functions of the z-piezo displacement. This permits simultaneous monitoring of the conductivity, the immersion depth, and the length and integrity of the nanotube probe. For uncoated SWNT probes, the nanotube bends or buckles elastically at higher loads and does not deflect the cantilever. The distance between the point at which the oscillation amplitude decreases to zero and the point at which the deflection of the cantilever is detected indicates the protrusion length of the nanotube. For SWNT probes coated with the polymer, the amplitude and deflection signals are modified slightly due to the increased rigidity of the coated nanotube. The coated nanotube can now deflect the cantilever as it makes contact with the surface, but to a lesser extent than the more rigid silicon tip apex. Thus, there is a change in the slope of the deflection signal when the silicon tip apex makes contact with the surface. The damping of the oscillation amplitude relative to the changes in the deflection signal of the probe as it comes into contact with the mercury drop allowed us to discriminate between the regions where only the coated nanotube is immersed in the mercury from where the larger more rigid silicon or gold coated silicon tip contacts the liquid.

Two types of measurements were performed. For a fixed potential applied to the tip, the current and probe deflection were monitored as the tip was immersed into the Hg drop. Alternatively, at fixed z-displacement, current-potential curves were recorded, either in the region where only the nanotube was immersed, or where the entire probe assembly (nanotube and AFM pyramidal tip support) was immersed in the Hg droplet. The immersion depth was kept constant (for long enough times to capture I-V curves) by fixing the z-scan start of the piezo at a certain value and by imposing a zero value for the scan ramp size. The current from the mercury contact was measured at virtual ground and converted to voltage by a current preamplifier (Keithley 486 picoammeter). Simultaneous measurement of the current and tip deflection was accomplished as a function of the immersion depth by feeding the preamplifier output back into the Nanoscope IV controller through the signal access module.

The electrical conductivity of the fluorocarbon polymer coated nanotube probe was first measured as a function of immersion depth in liquid Hg in order to test the insulating properties of the polymer. This is shown in FIGS. 14D-E for a probe consisting of a 100 nm long insulated nanotube attached to a gold coated silicon probe. I-V curves were captured at two different immersion depths as indicated by regions A and B in the amplitude and deflection versus z-displacement traces. Region A corresponds to the deflection of the coated nanotube only while region B, defined by the change in slope of the deflection signal, corresponds to physical contact of the AFM tip support with the Hg.

As plotted in FIG. 14F, before electrical pulse etching, no current was recorded above the detection limit of our picoammeter at any immersion depth for potentials ranging from −1.5 V to 1.5 V. However, as shown in FIG. 14G, after a 5 V, 10 μs electrical pulse was applied to the probe, a large current flowed through the nanotube to the Hg contact. The I-V curve is symmetric with a low-bias resistance of 177 kΩ, close to previously reported contact resistance of bare metallic nanotubes (or nanotube bundles) attached to gold coated AFM tips. It is important to note that no significant change in the current was detected between curves A and B, either before or after the polymer was etched. This shows unambiguously that the insulating polymer coating of the entire probe has been preserved intact except at the very end of the nanotube.

The TEM image shown in FIG. 14F is a subsequent TEM image of the same probe used to generate the data in FIGS. 14D-G. The image shows that as a consequence of the pulse, the probe had been shortened to 80 nm, which matches the length determined from amplitude and deflection curves taken for this probe after pulse etching. The fact that these data were taken after the conductivity experiments indicates that these probes are very robust, and can survive multiple experimental procedures under very different conditions and at different locations. The diameter of the nanotube probe was 15 nm, which would correspond to ˜5 nm polymer coating thickness, assuming the diameter of this SWNT was equal to the average value of 5 nm. Coating thicknesses in the range 5-10 nm were consistently obtained using the plasma conditions employed here.

The electrical pulse sharply cut the coated nanotube without significant removal of the polymer coating the sidewalls of the nanotube above the etched point. Close inspection of the TEM image shows structure that may be a signature of the etching process, although the lack of contrast between the fluorocarbon polymer and the nanotube in the image renders visual confirmation of tip exposure difficult. It is also plausible that local heating by the electron beam in the TEM caused some healing of the etched polymer. Local morphological changes of bare SWNTs due to heating effects in TEM have been reported previously.

In addition to highly conductive nanoelectrode probes assembled from metallic SWNTs on gold tips, we have also observed various kinds of semiconducting behavior from nanoelectrodes as shown in FIGS. 14H-J. For FIG. 14H, a 250 nm long nanotube was attached to a gold coated silicon probe. As before, no current was recorded from the insulated probe either as a function of the immersion depth or as a function of the voltage. After applying a 5 V etching pulse, the nanotube was shortened to 135 nm and the resulting I-V curve exhibited non-linear and asymmetric conductivity with a low-bias resistance of 850 MΩ, consistent with the behavior of a semiconducting nanotube.

The I-V curve in FIG. 14I was generated from a 180 nm long insulated nanotube attached to a gold coated silicon probe. After a 5 V etching pulse, a highly asymmetric current starts to flow. This positive rectifying behavior may be due to the formation of a metal-semiconductor heterojunction in the nanotube. Similar transport behavior has been observed in measurements of the I-V characteristics on isolated kink junctions connected to gold electrodes. Nanotube heterojunctions can be induced either by the formation of a pentagon-heptagon (5-7) defect pair during the growth process, or by mechanical perturbations of the nanotube. The rectifying diode-like behavior for the nanotube depicted in FIG. 14I was constant during repeated cycling of the probe in the Hg drop, which implies that if a heterojunction was responsible for this behavior, it likely was a result of a 5-7 defect or an irreversible mechanical deformation that occurred prior to the measurement. Rectifying behavior could be definitively assigned to a semiconductor-metal heterojunction, since it was measured across a sharp kink in the nanotube, imaged with AFM. For the probe in FIG. 14I, perturbation of the electrical contact of the nanotube with the gold tip and/or the mercury by the insulating coating could be a possible alternative mechanism, although we found that the coating and selective removal of the fluorocarbon polymer did not affect the contact resistances of metallic SWNTs on gold AFM tips, which were about 110 kΩ.

The I-V curve in FIG. 14J was from a probe fabricated from an uncoated silicon tip and shows diode-like behavior with strong current rectification at negative bias. The limiting barrier for conduction through the probe in this case is the 1-2 nm thick native silicon oxide layer that forms between the carbon nanotube and the n-type silicon tip. There is a much smaller Schottky barrier between the nanotube and the Hg, leading to the strongly asymmetric I-V curves observed. Control experiments with uncoated silicon AFM tips immersed in Hg (no nanotubes) showed similar behavior, although at much higher current densities (see supporting information). This is consistent with a mercury-insulator-silicon (n-type) tunnel junction having significantly higher currents at forward bias (negative potential applied to the tip) than the saturation current at reverse bias. The electronic nature of the nanotube (metallic or semiconductor) for this probe thus cannot be determined from this measurement due to the strong influence of the silicon contact, which determines the overall electrical behavior of the system.

FIG. 14K plots current density versus potential for such a Teflon-like polymer film formed on gold electrodes by the gas-phase reaction of C₄F₈. The insulating properties were determined by measuring the current involving the oxidation of ruthenium (II) hexaammine:
Ru(NH₃)₆²⁺→Ru(NH₃)₆³⁺+e⁻
as a function of film thickness in an electrochemical cell. Similar behavior was observed with graphite electrodes.

FIG. 14L shows an AFM image of a planar, highly oriented pyrolytic graphite (HOPG) substrate coated a Teflon-like polymer film formed by the same type of gas-phase reaction responsible for forming the passivation layer on the SWNT shown in FIG. 14C. The thickness of the deposited polymer film is 3 nm. FIG. 14M shows the conformal nature of the coating, as the polymer layer closely follows the step edges.

A roughness analysis was performed on the substrate whose AFM image is shown in FIG. 14M. Root-mean-square (rms) roughness in the boxed region is 0.238 nm. FIG. 14M shows that polymer coating is very smooth. Step edges in the graphite are identifiable, indicating that coating is conformal.

The experimental results demonstrate a method according to embodiments of the invention for coating a picked up individual SWNT with a conformal Teflon-like polymer film formed by the gas-phase reactions of octofluorocyclobutane in an inductively coupled plasma reactor. Nanoelectrode scanning probes were fabricated by localized electric pulse etching of the polymer at the nanotube apex. The use of plasma reactions at room temperature to coat the nanotube probes is advantageous compared to coating via other methods such as electrochemical polymerization or high temperature CVD since it offers a higher degree of control not only of the film thickness but also its chemical composition, including the fluorine content. A wide variety of metastable reactive species such as ions and radicals can be produced in the plasma, the relative concentrations of which can be fine-tuned by the operating conditions. This level of control allows us to coat the SWNTs primarily by polymerization reactions involving highly reactive free radicals generated under mild conditions instead of by ion bombardment, which damages nanotubes. Ellipsometry and XPS measurements of the film thickness on flat surfaces as well as TEM images of coated nanotube probes as functions of plasma parameters such as rf power, gas composition and flow have allowed us to find the optimal operating conditions that consistently result in film thicknesses of 10 nm±5 nm. The films have a composition closely resembling that of Teflon, an inert plastic that has excellent resistivity and dielectric strength, properties that can be useful for chemically passivated and electrically insulated nanoelectrodes. The coatings reinforce the attachment site of the nanotube with the AFM tip support without the need of an adhesive. This increases the mechanical stability of the nanotube, enabling the use of higher aspect ratio SWNT probes with a moderate decrease in topographic resolution. These coatings may also improve the electrical contact characteristics relative to picked up nanotubes attached to conductive AFM tips by adhesives or van der Waals forces. This has allowed us to fabricate semiconducting nanoelectrodes involving individual SWNTs, which may be useful as nanoscopic electrophotonic transducers.

ii. Metal and Metal Oxide Coatings and Functionalization of SWNTs

Embodiments also include methods of coating single-wall carbon nanotube (SWNT) atomic force microscope (AFM) tips with thin films of titanium metal and/or titanium oxide of controlled thickness, using an electron-beam evaporator. Evaporated titanium and titanium oxide coatings have been shown to have good wetting characteristics on suspended SWNTs. These coated nanotubes are hydrophilic coatings that lower the energy barrier when immersing the probes in aqueous environments. The ends and sidewalls of uncoated carbon nanotubes are hydrophobic, which presents challenges to incorporating them into functional scanning probes in water and aqueous solutions. SWNT tips can be irreversibly damaged, or even stripped from the AFM tip support upon contacting water, unless the nanotube is shortened to lengths less than about 100 nm (e.g., less than 50 nm).

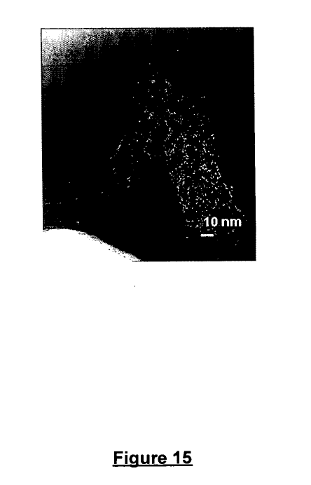

FIG. 15 shows a transmission electron microscope (TEM) image of a 5 nm diameter SWNT AFM tip that was originally 200 nm long before contact with water, but had inelastically buckled upon itself multiple times due to the immersion of the tip. The “bright” region in the bottom left hand corner of the image is the silicon AFM tip support, and the “triangle” structure connected to it is the buckled nanotube. The collapse of the nanotube resulted in a significant decrease in topographical imaging resolution. This particular probe tip was actually an exception to what more commonly occurred: the majority of SWNT tips with lengths greater than 100 nm were completely stripped from the AFM support upon immersion. This was ameliorated somewhat by the inclusion of a small amount (0.1% by volume) of the nonionic surfactant Tween-20 in the water, but the nanotubes were still bent or buckled.

Stable operation of nanotube AFM tips in liquids has been demonstrated by shortening individual SWNTs, or by employing SWNT ropes or multiwall carbon nanotubes (MWNTs), all of which increase the effective stiffness of the probe. Shorter SWNT tips with lengths less than 50 nm are robust enough to survive water immersion and can provide ultrahigh resolution topographical imaging capability in aqueous environments. Bundles of SWNTs or MWNTs are stiffer than individual SWNTs, and can be used as high aspect ratio probes that can operate in contact mode AFM as well as tapping mode. On the other hand, there are drawbacks to these approaches: SWNT ropes and MWNTs can lack the spatial resolution and the specificity of an individual SWNT that is uniquely functionalized at its tip. Individual SWNTs with lengths less than 50 nm can not extend far enough from the silicon tip apex to be useful as high aspect ratio, minimally invasive nanoelectrodes that can operate in complex physiological environments, including within and between live cells.

Embodiments of the invention include evaporating 5-10 nm of titanium on single-wall nanotubes attached to AFM tips results in AFM probes that survive immersion in water or aqueous solutions. In addition, the titanium can be oxidized upon exposure to air, or oxidized in oxygen-rich plasma to form TiOₓ coated nanotubes. Titanium oxide is a wide band gap semiconductor, an electrical property, which may prove useful for device fabrication when integrated on a conducting SWNT AFM probe.

Titanium deposition was carried out in a manner similar to that described by Y. Zhang and H. Dai, “Formation of metal nanowires on suspended single-walled carbon nanotubes” [Applied Physics Letters 2001, 77, 3015-3017], the entire contents of which is hereby incorporated by reference for all purposes. This is the first description of the concept of coating freely suspended SWNTs with titanium. One difference is that present methods attach only one end of the SWNT to the AFM tip support, leaving the other end free in space. In contrast, Zhang and Dai suspend the SWNT over the void spaces of a holey gold TEM grid with the nanotube was affixed to the grid support on both ends, and has the central portion between the two fixed ends freely suspended.

In one experimental example, the SWNTs were grown by chemical vapor deposition and mounted onto either bare silicon AFM tips (FESP, Nano World) or gold-coated tips (evaporation of 10 nm chromium followed by 50 nm gold). A Digital Instruments Multimode AFM with Nanoscope IV controller was used for this work. The evaporation was carried out in a commercial electron beam evaporator (CHA). The SWNT AFM probes were mounted on an electrically grounded sample stage in the evaporator at room temperature. A quartz crystal oscillator was used to monitor film thickness. The metal deposition rate was controlled at 0.1 nm/sec. The SWNT probes, before and after coating, and finally after water immersion, were characterized with a Phillips EM430 TEM operating at 300 kV.

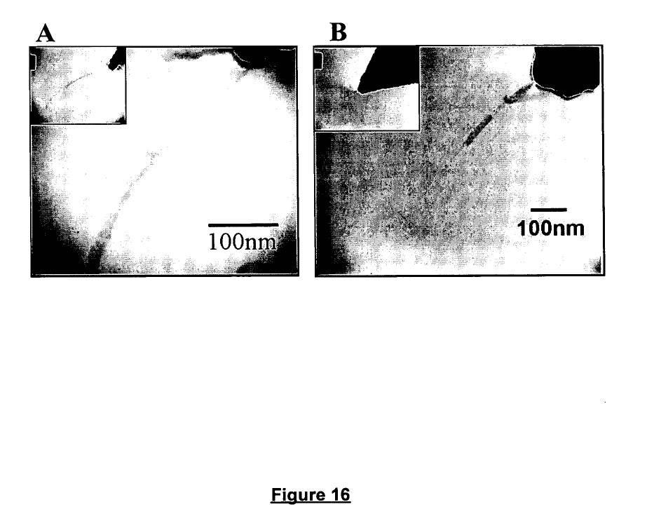

The titanium coated SWNT probes were tested for survivability toward water immersion by holding the AFM cantilever assembly with a pair of tweezers and dipping the probe by hand into pure water (18 MΩ resistivity, Millipore). FIG. 16 is a TEM image of a probe that had been coated with titanium before immersion in water and FIG. 16B is a TEM image of a (different) probe after it had been immersed in water. The titanium/titanium oxide film enabled the successful immersion in water of a probe that was approximately 200 nm in length without damaging the probe, as evidenced by FIG. 16B.

The various techniques forforming coatings just described, may be employed alone or in combination. Thus formation of a coating by gas phase deposition of a polymer, in the presence or absence of a plasma, may be performed in conjunction with surfactant exposure.

As note above, coated SWNTs may be functionalized by removing or modifying this inhibiting coating at the free end of the nanotube, typically through application of an electrical pulse. In one set of embodiments, this passivating coating is removed at the free end of the SWNT by ablation from the electrical pulse.

The exposed free end of the SWNT could be left uncoated, and serve as a scanning probe nanoelectrode. The nanoelectrode could function as an amperometric electrode or as a potentiometric electrode.

The nanoelectrode device would be useful in single molecule electrochemical studies, including but not limited to use in a novel scanning patch clamp apparatus for measuring and/or stimulating ion channel, G-coupled protein receptors, or other transmembrane protein activity, both in in vitro reconstituted systems as well as in cells. This probe could be brought within the Debye length (˜10 Å) of a protein like an ion channel, enabling one to measure local currents and/or electrical potentials at and in the vicinity of single ion channels.

New bioelectrochemical experiments can be envisioned utilizing such nanoscale scanning probes in accordance with embodiments of the present invention. Such applications include but are not limited to the detection, or production via reduction-oxidation chemistry, of physiologically active ligands, such as hormones, neurotransmitters, nucleotides and peptides as a function of electrode potential.

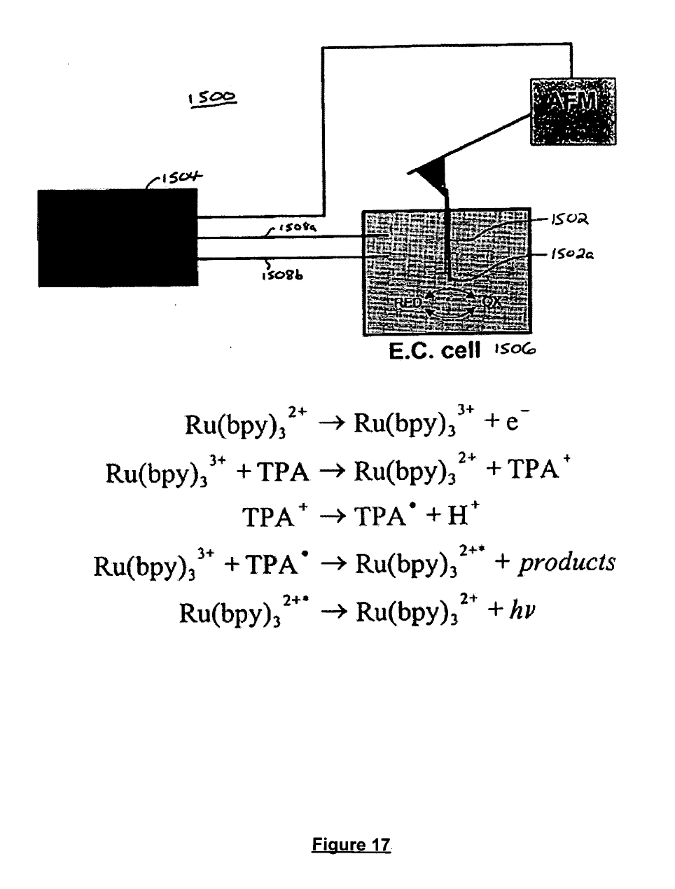

FIG. 17 shows a simplified view of apparatus 1500 utilizing an uncoated tip 1502a of a SWNT 1502 as a probe for detecting a localized electrochemical reaction. By utilizing potentiostat 1504 to measure a changed voltage on SWNT 1502, the electrochemical environment within cell 1506 could be monitored on a highly localized level.

Apparatus 1500 of FIG. 17 could also be utilized to influence or trigger an electrochemical reaction on a highly localized scale. Specifically, application of electronic energy in the form of a potential or current to the SWNT, would create an electric field at the exposed end of the SWNT structure.

In one approach, the changed electrical environment resulting from the application of electrical energy from the exposed SWNT tip, could be detected by electrodes 1508a and 1508b present in cell 1506 and in direct communication with potentiostat 1504. However, the small amount of voltage applied in an extremely small area may render detection in this manner difficult or unfeasible.

iii. Semiconductor Coatings and Functionalization of SWNTs

Embodiments further include methods of coating single-wall carbon nanotube (SWNT) atomic force microscope (AFM) tips with thin films of silicon metal and/or silicon oxide or silicon nitride of controlled thickness. Conformal SiOₓ films may be formed on the SWNTs by plasma-assisted deposition of a Si precursor such as tetraethoxysilane [TEOS, Si(O—C₂H₅)₄]. Silicon oxide coatings have a number of advantages for in situ biological studies, including being hydrophillic, having good dielectric qualities, and being biocompatible. Silicon oxide thin films prepared by plasma-assisted chemical vapor deposition from TEOS have been used extensively in very large-scale integration (VLSI) technology for constructing multilevel interconnects in integrated circuits, and the chemical and physical issues associated with SiOₓ film deposition from such precursors are well understood. Furthermore, amorphous SiOₓ layers deposited at higher temperatures will result in cross-linked coatings which improve the rigidity of the nanoprobe. The coating processes of the present invention permits characterizing the nanoelectrode probes on an individual by individual basis.

Coating the carbon nanotubes with SiOₓ may proceed in a fashion similar to the fluorocarbon coatings, for example by using an ICP plasma reactor with the nanoprobes on a grounded platen downstream. The quality of silicon oxide deposited from TEOS will be influenced by the substrate temperature, as occurs in the deposition of interlevel dielectric in semiconductor chip fabrication. This suggests that the nanoprobes may have to be heated to temperatures up to about 300° C. Nanotube stability is known to be excellent when heating to temperatures upward of 500° C. Preliminary experiments in air suggest that heating to 200° C. can improve the attachment of nanotubes to a gold-coated AFM tip: a greater percentage of nanotubes prepared in this manner survived water-immersion. In addition, the use of reactive metal coatings on the AFM Si tips to encourage stronger bonding of the carbon nanotube will be explored. For example, AFM tips may be coated with a thin (1-2 nm) layer of Ti in a metal evaporator.

Embodiments of the invention include a reactor to permit controllable heating of the nanoprobes during oxide deposition. SiOₓ layers will be deposited in the reactor on HOPG and silicon as a function of substrate temperature, TEOS composition, and plasma power. XPS may be performed on these layers to determine thickness and composition. In separate measurements, conformality and conductivity of the coatings may be assessed. The coated nanoprobes may be tested according to the mercury immersion protocol. This protocol includes exposing the carbon nanotube tip using electrical pulse etching, which can further serve to assess the integrity and conductivity of the coated carbon nanotube. Next, immersion in water in the presence and absence of surfactants will be examined. Based on current experience, survival after immersion in pure water is a good indicator of the success of the coating application.

Embodiments also include forming SiNₓ coatings on nanotubes such as SWNTs. Conformal SiNₓ films may be formed on the SWNTs by plasma-assisted deposition of a Si precursor such as tetraethoxysilane [TEOS, Si(O—C₂H₅)₄] combine with a nitrogen containing precursor such as ammonia (NH₃).

Beyond SiOₓ and SiNₓ coatings, other gas-phase polymerizing chemistries can produce coatings terminated with large numbers of —OH (e.g., glycol-based) or —NH₂ (peptide-based) moieties. In many cases, for nanotube probes to be useful as specific sensing and manipulation tools, the nanotubes must also be suitably passivated against irreversible non-specific binding of proteins. Coatings that have been proven to effectively resist non-specific binding of a number of different proteins to SWNTs include surfactants like Tween-20, which present highly hydrophilic and charge-neutral polyethylene-oxide segments that extend out from the probe into aqueous solution, which prevents non-specific adsorption due to hydrophobic or electrostatic interactions with proteins. After initial gas-phase polymerization of the nanotube probe with a conformal hydrophilic SiOₓ coating, surfactants could be applied in a subsequent step.

Alternatively, the successful application of electrical energy to a localized environment may be detected indirectly through electrochemical luminescence. Consider the following electrochemical reaction sequence:
Ru(bpy)₃²⁺→Ru(bpy)₃²⁺+e⁻
Ru(bpy)₃²⁺+TPA→Ru(bpy)₃²⁺+TPA⁺
TPA⁺→TPA^{•}+H+
Ru(bpy)₃³⁺+TPA^{•}→Ru(bpy)₃²⁺*+products
Ru(bpy)₃²⁺*→Ru(bpy)₃²⁺hν

The probes may also produce electrochemiluminescence. Oxidation of ruthenium bipyridine by the probe in the presence of a primary alkyl amine (such as tripropylamine) results in the formation of electronically excited triplet-state ruthenium bipyridine, which phosphoresces to the ground electronic state. Since this approach involves the detection of photons in a zero-background experiment, it may be more sensitive than measuring ultra-small electrical currents directly.

A third step in the functionalization of SWNTs attached to AFM probes involves attaching material, either through a covalent or non-covalent process, that enables specific interaction or binding at that fixed location.

As described in connection with the second step, the SWNT tip of the probe could be freed from passivation through the application of electrical energy. Such electrical pulsing in air also results in functionalization of the remaining end of the carbon nanotube with one or more carboxylate groups (—COOH).

Pulsing in other gases than air, such as H₂ or N₂, will introduce different functionality to the carbon nanotube end, allowing for an expansion of possible chemical coupling techniques.

Covalent coupling chemistry of the carboxylate moiety with reactive amino species, with EDC (1-ethyl-3-(3-dimethylaminopropyl)carbodiimide) as a catalyst, allows for the covalent attachment of many types of organic and biological species via formation of amide bonds. Examples of molecules attached in this way include but are not limited to DNA, proteins and fluorophores. Photo-activated or “caged” molecules, such as those presenting groups like benzophenone, could also be attached for light-directed capture of target molecules.

Alternately, the free end may have a different polymeric material adsorbed to it, with specific functionality for attachment of molecules of interest. For example, derivatives of PEG containing amino groups, thiol groups, cyano groups, biotin, or antibodies may be uniquely physisorbed at the free end to capture specific molecules in a complex sample.

Alternately, lower voltages or currents may be used to electrochemically modify a redox-active polymer, polyelectrolyte or self assembled monolayer (SAM) at the tube end to change its physical and chemical properties and affinity for specific analytes, either reversibly or irreversibly, but without destruction of the coating.

Alternately, an initially neutral coating at the tip may be electrically charged by application of the pulse, for electrostatic attraction of molecules. Examples of materials that could be used in this regard include, but are not limited to, polyaniline and polypyrrole and self assembled monolayers comprised of ferrocenyl thiols.

Alternately, a photoactive conjugated polymer, such as PmPV [poly{(m-phenylenevinylene)-co-[(2,5-dioctyloxy-p-phenylene)vinylene]}] or PPyPV [poly{(2,6-pyridinylenevinylene)-co-[(2,5-dioctyloxy-p-phenylene)vinylene]}] could be adsorbed. SWNTs wrapped with these polymers have shown interesting photogated effects on charge transport, including rectification and amplification of current flow.

These optoelectronic effects were pH dependent. A scanning probe fabricated with such material may serve as a nano-pH electrode.

Embodiments in accordance with the present invention may allow observation and even electrochemical control over single enzymatic reactions, allowing monitoring of fluorescence from a redox-active cofactor or the formation of fluorescent products. Enzymes “nanowired” to the tips of carbon nanotubes in accordance with embodiments of the present invention, may enable extremely sensitive probing of biological stimulus-response with high spatial resolution, including product-induced signal transduction.

In accordance with certain embodiments, covalent attachment of electrically active or fluorescent species such as some redox-active enzymes or cofactors used by these proteins to a functionalized SWNT nanoelectrode, could be used to study the effect of charge injection on enzyme activity. Analogous macroscopic electrode systems containing electronically coupled enzymes such as glucose oxidase are well known. For example, in “Plugging into Enzymes: Nanowiring of Redox Enzymes by a Gold Nanoparticle”, Science 299, 1877-1881 (2003), Xiao et al. showed that by quickly changing the potential applied to their “nanowired” electrode from 0 V to 0.7 V, glucose oxidase could be switched from an enzymatically inactive state to an active one.

In accordance with embodiments of the present invention, application of electrical potentials to functionalized SWNT probes will permit electrochemical control over individual redox events occurring during enzymatic turnovers of glucose oxidase, thereby permitting development of a single-molecule “enzymatic switch”. Such an enzymatic switch integrated on a SWNT-based scanning probe will create a mechanism to deliver an exact number of product molecules to a specific location with precise spatial positioning.

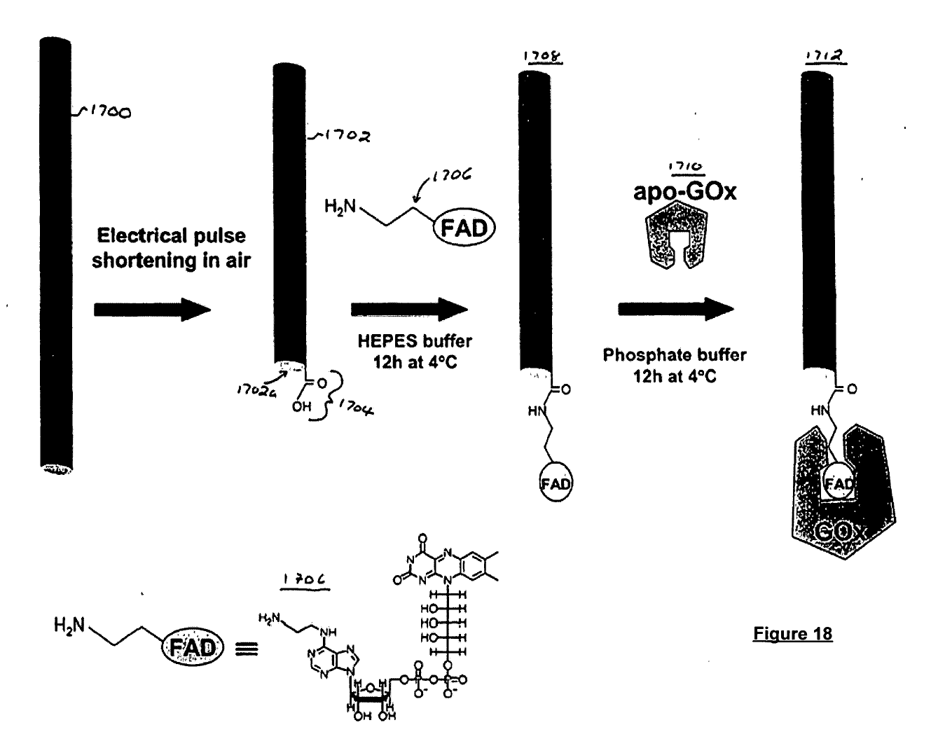

For example, FIG. 18 shows fabrication of such a nanoelectrode in accordance with one embodiment of the present invention. As shown in FIG. 18, nanotube 1700 attached to an AFM tip (not shown) and coated to preclude non-specific binding, is shortened by exposure to an electrical pulse in air, producing SWNT 1702 having tip 1702a bearing carboxylate group 1704 (COOH). The cofactor flavin adenine dinucleotide (FAD) 1706 is then covalently attached to the SWNT tip (in HEPES buffer for 12 hours @ 4° C.) to form nanoelectrode 1708.

Nanoelectrode 1708 in turn allows an apo-enzyme such as apo-glucose oxidase (apo-GOx) 1710 to reconstitute an active site around the immobilized FAD (in phosphate buffer for 12 hours @ 4° C.). The result is nanoelectrode 1712 functionalized with a single enzyme, glucose oxidase. Nanoelectrode 1712 allows for transduction of enzymatic activity to a measurable electrical current or fluorescence signature.

Moreover, this concept could be generalized to operate with any redox-cofactor containing enzyme that can be reconstituted from its corresponding apo-protein. For example, a nanoelectrode fabricated with a single glutathione reductase (GR) enzyme could be used as a sensitive probe for glutathione-modulated Ca²⁺ signal transduction cascades triggered by membrane bound N-methyl-d-aspartate (NMDA) receptors in neurons.

GR uses both FAD and NADPH (nicotinamide adenine dinucleotide phosphate) cofactors during the reduction of dimeric glutathione (GSSG) to its monomeric species (GSH). GSH has been implicated as a relatively uncharacterized neurotransmitter and neuromodulator in both the brain and central nervous system. Extracellular GSH initiates the inositol-1,4,5-triphosphate (IP₃)/Ca²⁺ signal transduction cascade via a NMDA-receptor activation event, while GSSG appears to have an inhibitory effect.

In “A Glutathione Amperometric Biosensor Based on an Amphiphilic Fullerene Redox Mediator Immobilised within an Amphiphilic Polypyrrole Film”, S. J. Mat. Chem. 12, 1996-2000 (2002), Carano et al. successfully demonstrated integration of GR into amperometric electrodes which can be “turned on” at appropriate voltages.

A GR-functionalized SWNT enzyme probe in accordance with embodiments of the present invention could be switched on for a specific amount of time for the generation of an appropriate, predetermined amount of GSH molecules in the vicinity of a single NMDA receptor or a cluster of receptors. The subsequent evolution of the intracellular Ca²⁺ concentration could then be monitored in real time using a Ca²⁺-dependent cell-permeant fluorophore such as Fluo-3 (Molecular Probes). This would permit observation of the transduction cascade triggered from a point source, as well as determination of the threshold GSH stimulus.

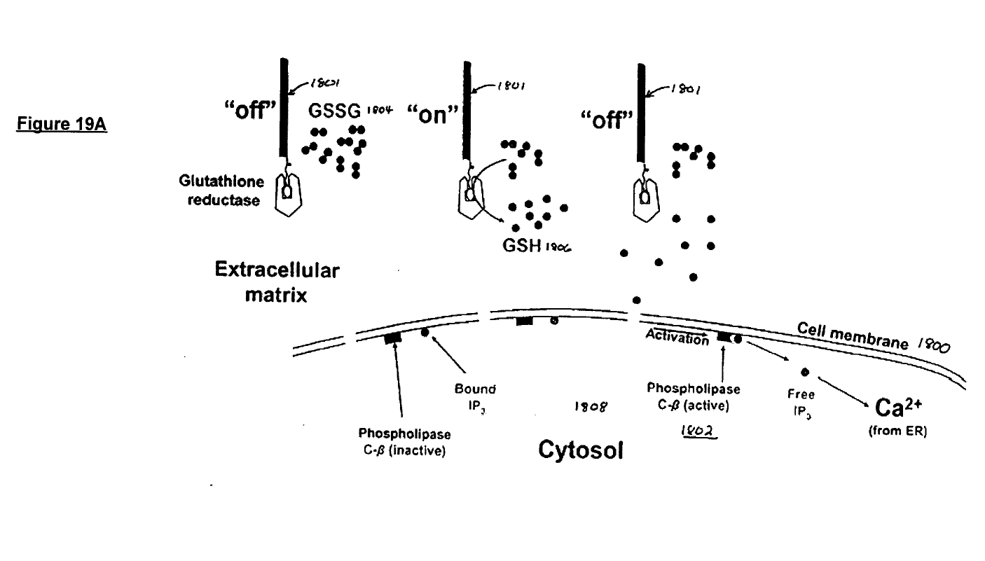

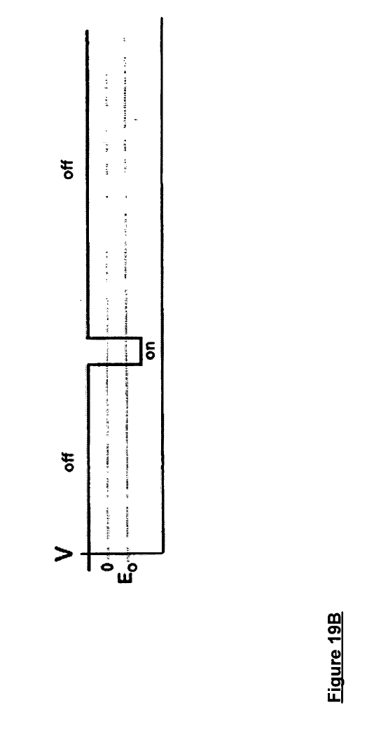

FIG. 19A shows a process for measuring the threshold stimulus required for initiating an intracellular calcium signal transduction cascade. FIG. 19B plots the electrical voltage signal of the nanoelectrode driving this process.

Electrode 1801 comprising glutathione reductase (GR) nanowired to the SWNT tip, is positioned adjacent to membrane 1800 of target cell 1802. A potential is applied to the SWNT and the GR is electrochemically activated. As a result of this activation, the GR reduces a predetermined amount of dimeric glutathione (GSSG) molecules 1804 to the monomeric thiol (GSH) species 1806.

The GSH 1806 then binds to membrane bound protein-coupled receptors 1808, initiating the inositol triphosphate signal transduction pathway and triggering a rise in intracellular Ca²⁺. This rise in the intracellular Ca²⁺ ion may be observed with a calcium-dependent fluorophore.

The above discussion introduces a general method for studying the initiation and propagation of biochemical reaction pathways using enzymatically-driven chemical triggers precisely defined in spatial and temporal coordinates, and in chemical magnitude. By carefully selecting an appropriate biochemical process, such as a signal transduction cascade, this method could elucidate the signal propagation rate and timing between individual chemical steps, or determine the minimum biochemical threshold for initiation.

By contrast, the conventional bulk studies related to the single-molecule, single-stimulus experiments described above, can only determine thresholds in ligand concentrations. These conventional studies would therefore be unable to distinguish repeated stimulation of a single receptor, from single stimulation of multiple receptors.

By contrast, experiments conducted utilizing functionalized SWNT probes in accordance with embodiments of the present invention could make this distinction. SWNT-functionalized probes in accordance with embodiments of the present invention should also exhibit enhanced sensitivity to the effects of receptor clustering and other receptor-receptor interactions, revealing interconnectivity details of multiple signaling pathways in both space and time.

Embodiments of applications for probes in accordance with the present invention are not limited to covalent bonding to the SWNT tip. In accordance with other embodiments, a noncovalent bonding mechanism could also be exploited.

For example, in “Noncovalent Sidewall Functionalization of Single-Walled Carbon Nanotubes for Protein Immobilization”, J. Am. Chem. Soc. 123(16), 3838-9 (2001), Chen et al. report noncovalent functionalization of SWNT sidewalls with bifunctional molecules having a pyrenyl group on one end and a succinimidyl ester on the other end. The pyrenyl group is highly aromatic and interacts strongly with the basal plane of graphite and the sidewalls of carbon nanotubes by van der Waals interactions. The succinimidyl esters on the other end of the linker molecules are highly reactive toward amine groups on the surface of most proteins to form amide bonds. Embodiments in accordance with the present invention could utilize similar non-covalent interactions to functionalize the tips of SWNT probes.

4. Solid-State Coatings and Their Uses in the Fabrication of Nanomanipulators and Localized Sensors

Another general class of embodiments of the invention relate to coating SWNT scanning probes with one or more solid-state materials in conjunction with, or in addition to the soft materials described above. Examples include, but are not limited to, metals, semiconductors and insulators. These materials may be deposited onto the SWNT AFM tip by evaporation, plasma deposition, sputtering, molecular beam epitaxy or through electrochemical means such as electroplating or chemical condensation reactions.

In addition to expansion of possible biophysical applications, further specific embodiments of the invention may include electronic, magnetic, optical and superconducting solid-state nanosensors.

Many of these devices have analogs in microelectronics. Most solid state devices rely on junctions (Schottky barriers, tunnel junctions, etc.) to create a property. By properly matching the material layers, such junctions, or energy barriers, can be fabricated using the nanotube allowing creation of nanometer scale devices and sensors. Many of these will uniquely benefit though creation of either an active or conductive site or material properties alteration achieved by application of a final shortening pulse. The exposed material is highly localized at the free end of the nanotube.

In one embodiment, the combination of such devices with a scanning probe microscope, such as a closed-loop controlled scanning probe microscope (SPM) such as an atomic force microscope (AFM), will enable ultraprecise position and probing of samples, materials and devices. The small size of these devices will enable exploration of properties for nanoelectronics and even molecular circuitry.

In one subset of embodiments, the SWNT AFM probe may be coated by a metal that has a specific chemical, biological or physical affinity for a target molecule of interest, or it may be further functionalized with a soft material such as a polymer or a self assembled monolayer for capture of a target molecule. Specific examples include, but are not limited to, chemisorption of alkyl thiols on gold surfaces and nitrilotriacetic acid on nickel (NTA-Ni). Alkyl thiols can have their free ends terminated with the same chemical moieties outlined in the previous section for attachment of molecules to derivatized PEG polymers. NTA-Ni has a strong affinity for histidine residues and is a common route for immobilizing proteins and polypeptides.

Metals may be either localized at the SWNT tip or they may be ablated exclusively off the tip. To fabricate a SWNT probe with metal only within a few nanometers from the free end, a resist may be coated onto the SWNT in preliminary step. The resist could comprise a polymer layer or other appropriate material applied to the probe, that can be selectively removed by exposure to an appropriate solvent in a subsequent step. Following ablation of the resist layer from the nanotube tip, the assembly is coated with the metal of interest. Subsequent lift-off of the resist in a suitable solvent (such as acetone) leaves a metal coating only at the very end of the nanotube.

Alternately, the coating could include multiple metals or combinations of metals, semiconductors, insulators (such as oxides) and soft materials. This will extend the types of applications and devices that may be constructed with this invention. Ablation of such a composite coating will result in the formation of a ring structure with a carbon nanotube core at the end face of the nanotube tip.

Composite layers consisting of metals, insulators and semiconductors are fundamental building blocks in many macroscopic solid-state devices. Examples include, but are not limited to, thermocouples based on the Seebeck effect, including Peltier heaters or refrigerators, superconducting quantum interference devices (SQUIDs), transistors, diodes and capacitors. This invention provides for the possibility of fabricating nanometer sized equivalents of these devices, located on the tip of a scanning AFM probe. Alternately these devices could be located on a substrate or structure such that nanopositioning stages can be used to control the relative locations of the materials, molecules, receptors, substrates and devices being characterized, probed, tested or controlled.

Alternately bi- and tri-metallic or polymer coatings or polymer/metallic coatings will enable electrically, thermally and chemically actuated manipulators to be constructed with a range of motion on-order of tube length and a precision on the order of 1 Å or less.

In summary, the localization of the functionalized or active sensing site, together with the ability to attach highly specific molecular sensors at this site, in combination with coatings which prohibit non-specific binding, enables construction of sensors, probes and devices with precise control of location. By combining these tools with existing technologies such as scanning probe microscopes (like AFM), we have the ability to control the position of these nanoscale sensors in such to study samples with exquisite sensitivity and resolution.

Alternately, the localization will enable the manufacture of sensors with active sites of sizes on order of a nanometer in diameter. These sensors and devices will enable extremely high precision and spatial resolution measurements to be conducted to characterize materials, and devices at the nanometer scale. In addition they will enable new classes of devices capable of characterizing and even controlling the behavior of molecular circuits. Finally these devices could be embodied as a new class of nanomanipulators.

And while the present invention has been described in connection with the translation of a functionalized SWNT relative to a target utilizing an AFM tip, embodiments in accordance with the present invention have a much broader range of applicability. In accordance with one alternative embodiment, a functionalized SWNT could be translated proximate to a target environment utilizing other than an AFM tool, for example a nanopositioner or nanoscanner as manufactured by Mad City Labs of Madison, Wis., or by Physik Instrumente (PI) of Karlsruhe, Germany. Still other possible techniques for positioning the functionalized nanotube involve translation of the sample relative to a stationary probe, for example by flowing a sample solution past a functionalized SWNT fixed in a microfluidic flow channel.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the electrode” includes reference to one or more electrodes and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

1. A coated nanotube comprising:
an inner nanotube having an exterior surface; and
a plasma deposited layer covering at least part of the exterior surface of the inner nanotube.

2. The coated nanotube of claim 1, wherein the inner nanotube is a carbon containing nanotube selected from the group consisting of a single-wall carbon nanotube, a multi-wall carbon nanotube, a plurality of single-wall carbon nanotubes bundled together, and a plurality of single-wall carbon nanotubes twisted into a rope.

3. The coated nanotube of claim 1, wherein the plasma deposited layer comprises oxygen and a metallic element.

4. The coated nanotube of claim 3, wherein the metallic element is titanium, and the plasma deposited layer comprises TiOₓ.

5. The coated nanotube of claim 1, wherein the plasma deposited layer comprises silicon oxide.

6. The coated nanotube of claim 1, wherein the plasma deposited layer comprises silicon nitride.

7. The coated nanotube of claim 1, wherein the plasma deposited layer comprises a fluorine containing polymer.

8. The coated nanotube of claim 7, wherein the plasma deposited layer comprises polytetrafluoroethylene.

9. The coated nanotube of claim 1, comprising at least one exposed site where the plasma deposited layer has been removed from a portion of the coated nanotube.

10. The coated nanotube of claim 2, wherein the exterior surface of the inner nanotube comprises a tip and a sidewall, and the exposed site in the plasma deposited layer is located at the tip of the exterior surface.

11. The coated nanotube of claim 9, wherein the plasma deposited layer is removed at the exposed site with an electric current traveling between the inner nanotube and a conductive substrate.

12. The coated nanotube of claim 11, wherein the conductive substrate is liquid mercury.

13. The coated nanotube of claim 11, wherein a sensing material is deposited in the exposed site.

14. The coated nanotube of claim 13, wherein the sensing material changes a measurable property of the coated nanotube when the material contacts an analyte.

15. The coated nanotube of claim 14, wherein the sensing material changes the measurable property in response to contact with a limited group of materials that includes the analyte.

16. The coated nanotube of claim 1, wherein the inner nanotube has a diameter from 1.6 to 3.0 nm.

17. The coated nanotube of claim 1, wherein the coated nanotube has a diameter of about 15 nm.

18. A method of making a coated nanotube, the method comprising:
generating a plasma from a coating precursor; and
exposing an inner nanotube to the plasma, wherein a plasma deposited layer is formed on at least a portion of the inner nanotube.

19. The method of claim 18, wherein the plasma is generated in an inductively-coupled plasma chamber.

20. The method of claim 18, wherein the method comprises grounding the inner nanotube.

21. The method of claim 18, wherein the inner nanotube is exposed to the plasma downstream from where the plasma is generated.

22. The method of claim 18, wherein about 50 W to about 75 W of power from a radio-frequency power source is used to generate the plasma.

23. The method of claim 18, wherein the method comprises removing a portion of the plasma deposited layer from the coated nanotube.

24. The method of claim 23, wherein the coating removed by an electric current traveling between the inner nanotube and a conductive substrate in contact with the coated nanotube.

25. The method of claim 24, wherein the method comprises depositing a sensing material on the inner nanotube where the plasma deposited layer has been removed.

26. The method of claim 18, wherein the coating precursor comprises argon, and a fluorine-containing compound.

27. The method of claim 26, wherein the fluorine-containing compound comprises octafluorocyclobutane.

28. A method of making a coated nanotube, the method comprising:
providing a nanotube; and
evaporating a metal into the inner nanotube, wherein the metal forms a coating layer on at least a portion of the inner nanotube.

29. The method of claim 28, wherein the metal comprises titanium.

30. The method of claim 28, wherein the metal is evaporated using an electron beam evaporator.

31. The method of claim 28, wherein the inner nanotube is a carbon containing nanotube selected from the group consisting of a single-wall carbon nanotube, a multi-wall carbon nanotube, a plurality of single-wall carbon nanotubes bundled together, and a plurality of single-wall carbon nanotubes twisted into a rope.

32. A coated nanotube comprising:
a nanotube having an exterior surface; and
a coating layer comprising a metal formed on at least a portion of the exterior surface of the inner nanotube.

33. The coated nanotube of claim 32, wherein the metal comprises titanium.

34. The coated nanotube of claim 32, wherein the nanotube comprises a single walled carbon nanotube.

35. A method of making a coated nanotubes, the method comprising:
growing a plurality of carbon nanotubes on a substrate; and
forming a coating layer on the carbon nanotubes to make the coated nanotubes.

36. The method of claim 35, wherein the plurality of carbon nanotubes comprise single-walled carbon nanotubes, which are grown by chemical vapor deposition.

37. The method of claim 35, wherein the substrate comprises a silicon wafer coated with a metal catalysis selected from the group consisting of iron, nickel, and iron-nickel.

38. The method of claim 35, wherein the plurality of nanotubes have substantially the same orientation on the substrate.

39. The method of claim 35, wherein the coating comprises a fluorocarbon polymer.

40. The method of claim 35, wherein the coating is formed by exposing the carbon nanotubes to a plasma made from coating precursors.

41. The method of claim 35, wherein the coating comprises a metal.

42. The method of claim 35, wherein the coating is formed by exposing the carbon nanotubes to an evaporated metal.

43. The coated nanotubes made by the method of claim 35.

44. A coated nanotube comprising a polymer coating that covers at least a portion of a sidewall of the nanotube, wherein a tip of the nanotube is not covered by the coating.

45. The coated nanotube of claim 44, wherein the polymer coating comprises a fluorocarbon.

46. The coated nanotube of claim 44, wherein the polymer coating electrically and chemically insulates the sidewall of the nanotube.

47. The coated nanotube of claim 44, wherein the coated nanotube is attached to a substrate, and the polymer coating mechanically stabilizes the nanotube to the substrate.

48. The coated nanotube of claim 44, wherein the nanotube is a single-walled carbon nanotube.
